(19) United States
(12) Patent Application Publication
(10) Pub. No.: US 2020/0137166 A1
(43) Pub. Date: Apr. 30, 2020

(54) REMOTE DEVICE MANAGEMENT SYSTEM, DEVICE, AND COMMUNICATION METHOD

(71) Applicant: Satoshi AOKI, Kanagawa (JP)

(72) Inventor: Satoshi AOKI, Kanagawa (JP)

(21) Appl. No.: 16/655,431

(22) Filed: Oct. 17, 2019

(30) Foreign Application Priority Data
Oct. 30, 2018 (JP) 2018-203854

(51) Int. Cl. H04L 29/08; H04L 29/06; H04L 12/24

(52) U.S. Cl. CPC H04L 67/125; H04L 41/12; H04L 63/029

(57) ABSTRACT

A remote device management system, a device, and a communication method. The remote device management system includes a plurality of devices residing on a local network and a management apparatus connected to the local network through a firewall and configured to communicate with a mediating apparatus residing on the local network. The plurality of devices includes a first device that communicates with the mediating apparatus and a second device that communicates with the first device in the local network. The first device stores second device identification information for identifying the second device, receives from the mediating apparatus a search request for a device transmitted from the management apparatus to the mediating apparatus, and transmits first device identification information for identifying the first device and the stored second device identification information to the management apparatus in response to the search request.

### CROSS-REFERENCE TO RELATED APPLICATIONS

This patent application is based on and claims priority pursuant to 35 U.S.C. § 119(a) to Japanese Patent Application No. 2018-203854, filed on Oct. 30, 2018 in the Japan Patent Office, the entire disclosure of which is hereby incorporated by reference herein.

### BACKGROUND

### Technical Field

The present disclosure relates to a remote device management system, a device, and a communication method.

### Background Art

A remote device management system can remotely manage devices in a local network such as a local area network (LAN) from outside the local network. The remote device management system, for example, includes a mediating apparatus capable of obtaining device information from a device in the local network. A management server located outside the local network implements remote management of the device by communicating with the mediating apparatus through a network firewall.

### SUMMARY

Embodiments of the present disclosure provide a novel remote device management system, device, and communication method. The remote device management system includes a plurality of devices residing on a local network and a management apparatus connected to the local network through a firewall and configured to communicate with a mediating apparatus residing on the local network. The plurality of devices includes a first device that communicates with the mediating apparatus and a second device that communicates with the first device in the local network. The first device stores second device identification information for identifying the second device, receives from the mediating apparatus a search request for a device transmitted from the management apparatus to the mediating apparatus, and transmits first device identification information for identifying the first device and the stored second device identification information to the management apparatus in response to the search request.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a diagram illustrating an example of a system configuration of a remote device management system according to a first embodiment of the present disclosure;

FIG. 2 is a diagram illustrating an example of a first overview of the remote device management system according to the first embodiment of the present disclosure;

FIG. 3 is a diagram illustrating an example of a second overview of the remote device management system according to the first embodiment of the present disclosure;

FIG. 4 is a block diagram illustrating an example hardware configuration of a computer according to the first embodiment of the present disclosure;

FIG. 5 is a block diagram illustrating an example of a functional configuration of a management system according to the first embodiment of the present disclosure;

FIG. 6 is a block diagram illustrating an example of a functional configuration of a mediating apparatus and devices according to the first embodiment of the present disclosure;

FIG. 7 is a diagram illustrating an example of a schematic model of a communication definition of a device according to the first embodiment of the present disclosure;

FIG. 8 is a diagram illustrating an example of a device management table according to the first embodiment of the present disclosure;

FIG. 9 is a diagram illustrating an example of parent device management information according to the first embodiment of the present disclosure;

FIG. 10 is a diagram illustrating an example of a child device management table according to the first embodiment of the present disclosure;

FIG. 11 is a sequence diagram illustrating an example of a device search process executed by the remote device management system according to the first embodiment of the present disclosure;

FIG. 12 is a diagram illustrating an example of a device search result display screen displayed on the management system according to the first embodiment of the present disclosure;

FIG. 13 is a sequence diagram illustrating an example of a device information registration process executed by the remote device management system according to the first embodiment of the present disclosure;

FIG. 14 is a diagram illustrating an example of a registered device display screen displayed on the management system according to the first embodiment of the present disclosure;

FIG. 15 is a sequence diagram illustrating an example of a device registration information deletion process executed by the remote device management system according to the first embodiment of the present disclosure;

FIG. 16 is a sequence diagram illustrating an example of communication from a remote device management apparatus to the device in the remote device management system according to the first embodiment of the present disclosure;

FIG. 17 is a sequence diagram illustrating an example of a device information acquisition process executed by the remote device management system according to the first embodiment of the present disclosure;

FIG. 18 is a sequence diagram illustrating an example of a device status notification process from the device to the remote device management apparatus by the remote device management system according to the first embodiment of the present disclosure;

FIG. 19 is a diagram illustrating an example of an overview of the remote device management system according to a second embodiment of the present disclosure;

FIG. 20A and FIG. 20B are diagrams illustrating examples of a schematic model of the communication definition of the device according to the second embodiment of the present disclosure;

FIG. 21 is a diagram illustrating an example of a device management table according to the second embodiment of the present disclosure;

FIG. 22 is a diagram illustrating an example of a parent device management table according to the second embodiment of the present disclosure;

FIGS. 23A, 23B, and 23C are diagrams illustrating examples of a child device management table according to the second embodiment of the present disclosure;

FIG. 24 is a sequence diagram illustrating an example of communication from the remote device management apparatus to the device by the remote device management system according to the second embodiment of the present disclosure;

FIG. 25 is a diagram illustrating an example of an overview of the remote device management system according to a third embodiment of the present disclosure;

FIG. 26A, FIG. 26B-1, and FIG. 26B-2 are diagrams illustrating examples of a schematic model of the communication definition of the device according to the third embodiment of the present disclosure;

FIG. 27 is a diagram illustrating an example of a device management table according to the third embodiment of the present disclosure; and

FIG. 28 is a diagram illustrating an example of a system configuration of the remote device management system according to another embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Embodiments of the present disclosure are described with reference to the drawings. In the description of the drawings, the same elements are denoted by the same reference numbers, and redundant description is omitted.

### First Embodiment

System Configuration

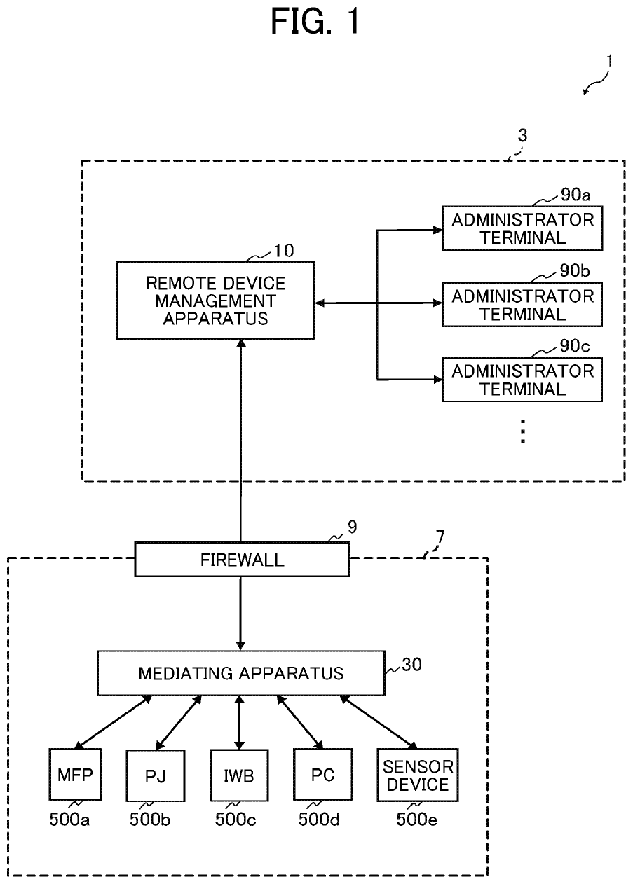

FIG. 1 is a diagram illustrating an example of a system configuration of a remote device management system according to a first embodiment of the present disclosure. The remote device management system 1 illustrated in FIG. 1 is a system that can manage devices 500 to be managed by a management system 3 even when there is a parent-child relation between the management system 3 and the devices 500 installed in a local network 7. The remote device management system 1 includes the management system 3, the local network 7 and a firewall 9. The local network 7 is connected to the management system 3 through the internet. The local network 7 and the management system 3 are connected using the firewall 9 as an interface.

The local network 7 is a communication network formed in a network environment such as an office, a conference room, a warehouse, a factory or a production line. The local network 7 is, for example, an internal local area network (LAN) that is not connected to the internet. The local network 7 includes a mediating apparatus 30, a multifunction peripheral (MFP) 500a, a projector (PJ) 500b, an interactive white board (IWB: electronic whiteboard capable of mutual communication) 500c, a personal computer (PC) 500d, and a sensor device 500e (for example, electronic balance, barometer, accelerometer, ammeter, thermometer, photometer, human sensor, camera, illuminance meter capable of communicating with outside). The WP 500a, the PJ 500b, the IWB 500c, the PC 500d, and the sensor device 500e are management target devices to be managed by the management system 3. The device 500 used in the following description is a generic name for these devices.

The firewall 9 blocks unintended or unauthorized access to the local network 7, and functions to allow only certain packets of information from the management system 3 through the internet into the local network 7. In addition, the firewall 9 transfers a packet from the mediating apparatus 30 to the management system 3.

The management system 3 is a system for managing the mediating apparatus 30 and the device 500 included in the local network 7. The management system 3 includes the remote device management apparatus 10 and a plurality of administrator terminals 90 (90a, 90b, 90c, hereinafter collectively referred to as an administrator terminal 90 when it is not necessary to distinguish among them).

The remote device management apparatus 10 is a server computer for managing information of the mediating apparatus 30 and the device 500 included in a plurality of local networks 7. The remote device management apparatus 10 is connected to the mediating apparatus 30 through the firewall 9, and remotely manages the device 500 in the local network 7 through the mediating apparatus 30. As an example of management, the remote device management apparatus 10 can acquire, from the MFP 500a, information related to a state such as the amount of toner remaining in a printer and the number of printed sheets. Also, the remote device management apparatus 10 can issue an instruction to execute printing of document data stored in the MFP 500a. In addition, the remote device management apparatus 10 controls the power for the PJ 500b, the IWB 500c, and the PC 500d. Furthermore, the remote device management apparatus 10 can obtain information acquired by the sensor device 500e from the sensor device 500e. The remote device management apparatus 10 may be configured as a single server computer or as a plurality of server computers.

The administrator terminal 90 is a terminal such as a notebook PC used by an administrator who monitors the device 500 using the remote device management system 1. The administrator terminal 90 provides the administrator of the remote device management system 1 with the information of the device 500 by displaying the device information of the device 500 managed by the remote device management apparatus 10 using a web browser. Also, the plurality of administrator terminals 90 can access the remote device management apparatus 10 from different locations. The remote device management apparatus 10 can manage applications to be provided to each administrator terminal 90 according to, for example, usage environment of the local network 7 and type of the device 500. The administrator terminal 90 may be, for example, a terminal equipped with the web browser such as a tablet terminal, a mobile phone, a smartphone, a wearable terminal, or a desktop PC.

The management system 3 may be configured to execute the functions of the remote device management apparatus 10 and the administrator terminal 90 in one apparatus.

The mediating apparatus 30 is an apparatus that mediates communication between the remote device management apparatus 10 and the device 500 in the local network 7. The mediating apparatus 30 maintains a session at all times to transmit messages from the remote device management apparatus 10 to the local network 7 across the firewall 9 and implements bidirectional communication between the remote device management apparatus 10 and the management target device 500 while ensuring security of the local network 7. The mediating apparatus 30 can communicate with the device 500 and the firewall 9 through a wired or wireless LAN or the like. The mediating apparatus 30 accesses the device 500 in response to an instruction from the remote device management apparatus 10, sends alerts from the device 500 to the remote device management apparatus 10, or executes information acquisition and life-and-death monitoring (for example, whether the device 500 can communicate or not) of the device 500 based on a preset schedule. The mediating apparatus 30 may be a box-type communication device functioning as a single unit or may be incorporated in an apparatus such as the MFP 500a.

Also, the mediating apparatus 30 can communicate with the remote device management apparatus 10 on the internet through the firewall 9. The mediating apparatus 30 is located in the local network 7 interfaced with the firewall 9 and the remote device management apparatus 10 included in the management system 3 is located outside the local network 7 with the firewall 9 as an interface.

The device 500 (MFP 500a, PJ 500b, IWB 500c, PC 500d and sensor device 500e) is located in the local network 7 with the firewall 9 as an interface. The device 500 is the management target device that is subjected to maintenance, counter reading, and the like by the management system 3. Further, the device 500 may attach a device having a network function to a terminal not having a network function such as a human sensor.

Although FIG. 1 illustrates an example in which the management system 3 remotely manages a plurality of devices 500 located in one local network 7, the management system 3 may be configured to remotely manage the devices 500 located in each of a plurality of local networks 7. In addition, although FIG. 1 illustrates an example in which one mediating apparatus 30 is located in one local network 7, two or more mediating apparatuses 30 may be located in one local network. In this case, the mediating apparatuses 30 may share functions.

Overview

Hereinafter, an overview of configuration of the remote device management system according to the first embodiment of the present disclosure is described.

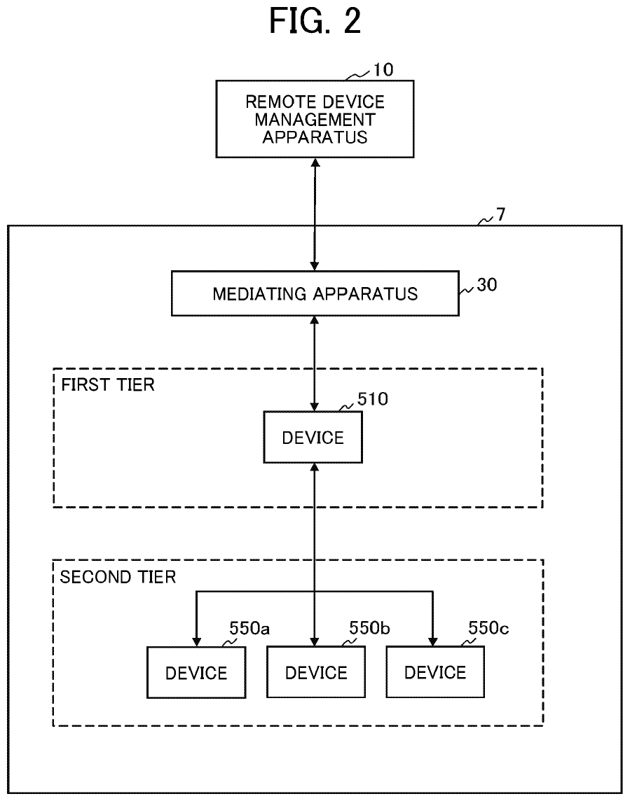

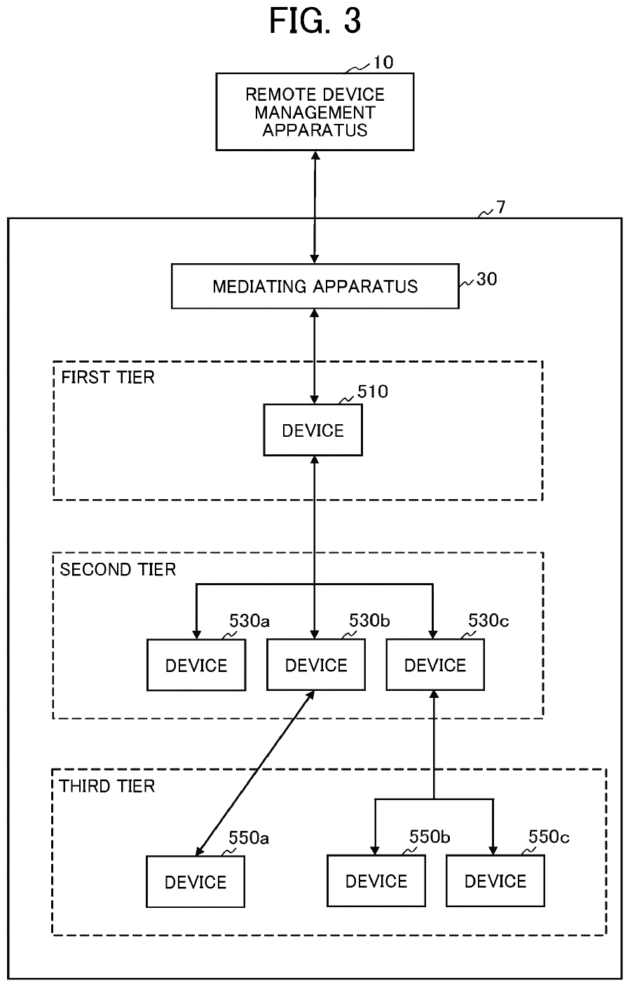

FIG. 2 and FIG. 3 schematically illustrate the overview of the remote device management system according to the first embodiment. Details of the functions and the like implemented by the remote device management system 1 are described below with reference to the drawings, etc.

FIG. 2 is a diagram illustrating an example of a first overview of the remote device management system according to the first embodiment of the present disclosure. In the remote device management system 1 illustrated in FIG. 2, four devices 500 (510, 550a to 550c) to be managed (monitored) by the remote device management apparatus 10 are included in the local network 7. As illustrated in FIG. 2, the plurality of devices 500 are hierarchized between a first-tier device 510 capable of communicating directly with the mediating apparatus 30 and a second-tier device 550 (550a to 550c) that cannot communicate directly with the mediating apparatus 30 but can communicate with the device 510 in the local network 7 are included.

Note that, although the mediating apparatus 30 can communicate with the devices 500 included in the same network as the management target device, there are cases where communication with the mediating apparatus 30 cannot be performed for a device that does not support a standard protocol such as HyperText Transfer Protocol (HTTP) or Simple Network Management Protocol (SNMP) or when the network is not a Transmission Control Protocol/Internet Protocol (TCP/IP) network. In the example illustrated in FIG. 2, the mediating apparatus 30 can communicate with only the device 510, and the device 510 can communicate with the devices 550a to 550c in the local network 7. The device 550 exchanges various data (information) with the mediating apparatus 30 through the device 510.

Another example of the configuration of the remote device management system 1 is described below. FIG. 3 is a diagram illustrating an example of a second overview of the remote device management system according to the first embodiment of the present disclosure. The difference between the remote device management system 1 illustrated in FIG. 2 and the remote device management system 1 illustrated in FIG. 3 is that the devices 500 to be managed (monitored) by the remote device management apparatus 10 includes not only the second tier device 530 (530a to 530c) but also the third tier device 550 (550a to 550c).

Among the devices 530 of the second tier, the device 530b and the device 530c transmit various data (information) transmitted from the device 510 to the device 550 of the third tier because other devices exist under the control of the own device. At the same time, various data (information) transmitted from the device 550 of the third tier are transmitted to the device 510 of the first tier. In the example illustrated in FIG. 3, the device 530b of the second tier communicates with the device 550a of the third tier in the local network 7. Also, the device 530c of the second tier communicates with the devices 550b and 550c of the third tier in the local network 7.

As illustrated in FIGS. 2 and 3, the remote device management system according to the first embodiment has a parent-child relation in which the devices 500 included in the local network 7 are hierarchized. The device 530 of the second tier that cannot communicate directly with the mediating apparatus 30 communicates with the device 510 of the first tier that can communicate directly with the mediating apparatus 30 in the local network 7. Also, the device 550 of the third tier communicates with the device 530 of the second tier in the local network 7. When the remote device management system 1 has a parent-child relation with the device 500 in the local network 7, the management system 3 can manage even the device 500 which cannot communicate directly with the mediating apparatus 30, by the device (530 or 550) belonging to the lower tier communicating with the mediating apparatus 30 through the device (510 or 530) of the upper tier.

In the following description, a device under which another device is present plays a role as a parent device, among the plurality of hierarchically organized devices 500. In the example illustrated in FIG. 2, the device 510 is the parent device, and in the example illustrated in FIG. 3, the device 510, the device 530b, and the device 530c are the parent devices. On the other hand, among the plurality of hierarchically organized devices 500, the device 500 at the end of hierarchy is a child device belonging to a subordinate of the parent device. In the example illustrated in FIG. 3, the device 530a of the second tier and the devices 550a, 550b and 550c of the third tier are the child devices. The device that plays a role of the parent device is an example of a first device, and the child device subordinate to the parent device is an example of a second device. The device 500 playing a role of a parent device may only play a role of a relay device for communicating with devices under its own level and cannot be a management target (monitoring target) of the remote device management apparatus 10. In this case, the remote device management apparatus 10 may manage management target information indicating whether or not a device is a management target (monitoring target), in association with the device identification information for identifying the device 500.

Hardware Configuration

The hardware configuration of each device according to the first embodiment is described. Each device included in the remote device management system 1 has a general computer configuration. Here, a hardware configuration example of a general computer is described.

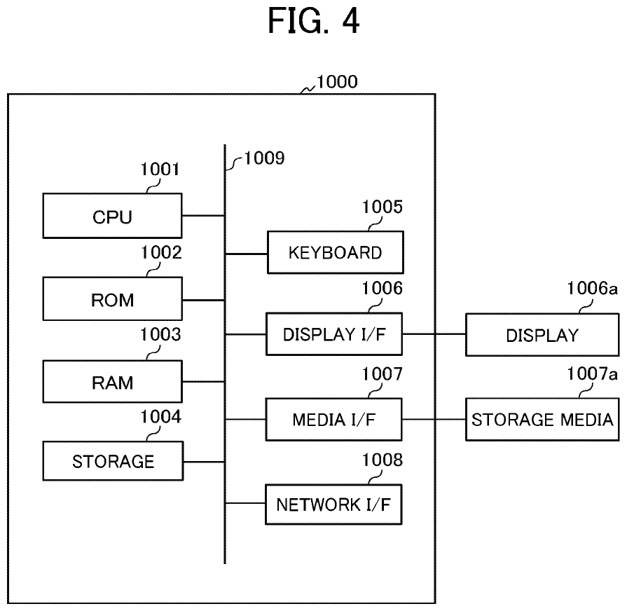

FIG. 4 is a block diagram illustrating an example hardware configuration of a computer according to the first embodiment of the present disclosure. The hardware configuration of the computer 1000 illustrated in FIG. 4 may have the same configuration in each embodiment, and components may be added or deleted as necessary. The computer 1000 includes a central processing unit (CPU) 1001, a read only memory (ROM) 1002, a random access memory (RAM) 1003, a storage 1004, a keyboard 1005, a display interface (I/F) 1006, and a media interface (I/F) 1007, a network interface (I/F) 1008, a bus 1009 and the like.

The CPU 1001 is an arithmetic device that implements each function of the computer 1000 by reading programs and data stored in the ROM 1002, the storage 1004, and the like on the RAM 1003 and executing processing. For example, the device 500 playing the role of the parent device (the device 510 illustrated in FIG. 2 and the device 510, the device 530b, and the device 530c illustrated in FIG. 3) implements the communication method according to the present disclosure by the CPU 1001 executing the program according to the present disclosure.

The ROM 1002 is a non-volatile memory that can hold programs and data even after the power is turned off. The ROM 1002 includes, for example, a flash ROM or the like. A software development kit (SDK) corresponding to various uses is installed in the ROM 1002, and the application of the SDK can be used to implement the functions of the computer 1000, network connection, and the like.

A RAM 1003 is a volatile memory used as a work area or the like of the CPU 1001. The storage 1004 is, for example, a storage device such as a hard disk drive (HDD) or a solid state drive (SSD). The storage 1004 stores, for example, an operating system (OS), an application program, various data, and the like.

The keyboard 1005 is a type of input device provided with a plurality of keys for inputting characters, numerical values, various instructions, and the like. The input device may be, for example, a mouse, a touch panel or a voice input device as well as the keyboard 1005. The display I/F 1006 controls display of various information such as a cursor, a menu, a window, characters, or an image on the display 1006a such as a liquid crystal display (LCD). The display 1006a may be a touch panel display provided with input device.

The media I/F 1007 controls reading or writing (storage) of data to a storage medium 1007a such as a universal serial bus (USB) memory, a memory card, an optical disk, or a flash memory.

The network I/F 1008 is an interface for connecting the computer 1000 to a network and transmitting and receiving data to and from another computer, an electronic device, or the like. The network I/F 1008 is, for example, a communication interface such as a wired or wireless local area network (LAN). The network I/F 1008 includes 3rd Generation (3G), long term evolution (LTE), 4th Generation (4G), 5th Generation (5G), Zigbee (registered trademark), EnOcean, Bluetooth (registered trademark) Low Energy (BLE), Near Field Communication (NFC), millimeter wave wireless communication, infrared communication, Quick Response (QR) code (registered trademark), visible light, communication interface such as environmental sound or ultrasonic.

The bus 1009 is commonly connected to the above-described components, and transmits an address signal, a data signal, various control signals, and the like. The CPU 1001, the ROM 1002, the RAM 1003, the storage 1004, the keyboard 1005, the display I/F 1006, the media I/F 1007 and the network I/F 1008 are mutually connected through the bus 1009.

In the hardware configuration of each device according to the first embodiment, components may be added or deleted as necessary. For example, the remote device management apparatus 10 may be configured without an input device such as the keyboard 1005 and the display 1006a. Further, the device 500 may be configured to include a module or the like for providing a function or service according to the type of each device.

Functional Configuration

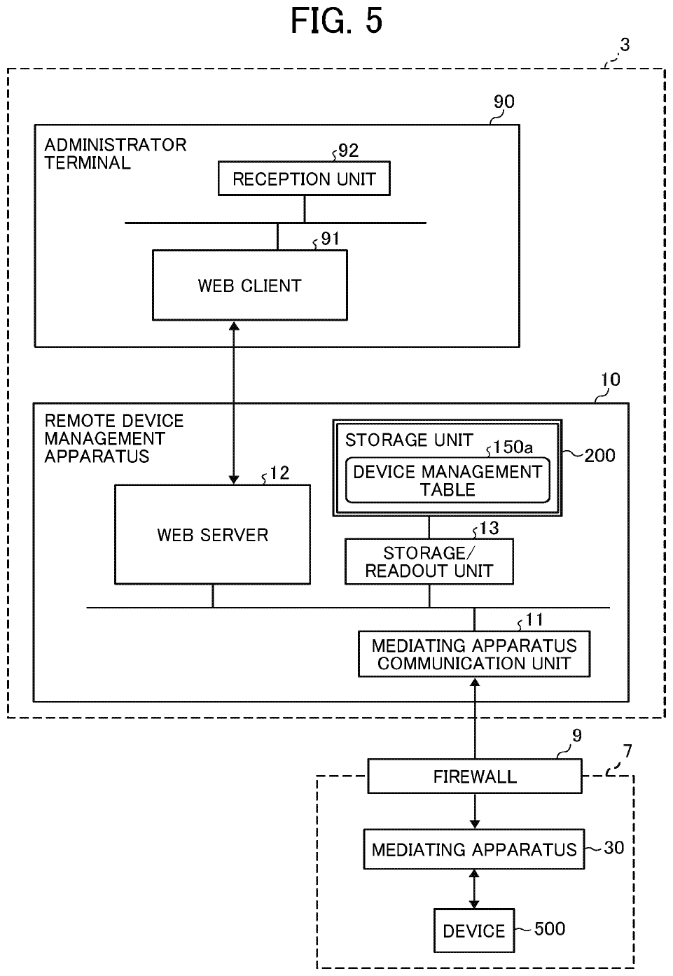

Hereinafter, a functional configuration of the remote device management system according to the first embodiment is described. The functional configuration of the remote device management apparatus 10 and the administrator terminal 90 included in the management system 3 is described below with reference to FIG. 5. FIG. 5 is a block diagram illustrating an example of the functional configuration of the management system according to the first embodiment of the present disclosure. The functions implemented by the remote device management apparatus 10 illustrated in FIG. 5 includes a mediating apparatus communication unit 11, a web server 12, a storage/readout unit 13, and a storage unit 200.

The mediating apparatus communication unit 11 exchanges data with the mediating apparatus 30. The mediating apparatus communication unit 11 controls communication with the mediating apparatus 30 located inside the local network 7 through the firewall 9. The mediating apparatus communication unit 11 receives polling to the remote device management apparatus 10 transmitted from the mediating apparatus 30, and transmits a response to the polling to the mediating apparatus 30. Alternatively, the mediating apparatus communication unit 11 maintains a communication session (such as Web Socket) so that the mediating apparatus 30 can always communicate with the remote device management apparatus 10, and performs various types of data interaction with the mediating apparatus 30. Either method may be used in the present embodiment.

The mediating apparatus communication unit 11 transmits, for example, a command issued by the web server 12 to the mediating apparatus 30. The command transmitted from the mediating apparatus communication unit 11 is an example of request information indicating a predetermined request for the device 500, for example. When a communication session (such as Web Socket) that can always communicate with the remote device management apparatus 10 from the mediating apparatus 30 is not used, then the remote device management apparatus 10 manages the transmission status of the command issued by the web server 12 with a state such as “not transmitted” or “transmission completed”. Further, the mediating apparatus communication unit 11 receives, from the mediating apparatus 30, a response to the command transmitted to the mediating apparatus 30, or status information indicating the status of the device 500, voluntarily transmitted from the device 500. The received information is transmitted to the web server 12 and displayed on the administrator terminal 90 using a web client. The mediating apparatus communication unit 11 is implemented, for example, by the network I/F 1008 and the program executed by the CPU 1001 illustrated in FIG. 4.

The web server 12 is a server for web applications. The web server 12 receives a request from the web client 91 via a web application programming interface (web API) using a communication protocol such as Hyper Text Transport Protocol Secure (HTTPS), performs processing according to the request, and responds to the web client 91. The communication protocol may include File Transfer Protocol (FTP), HTTP, and Simple Mail Transfer Protocol (SMTP). Further, when the remote device management apparatus 10 requires communication with the mediating apparatus 30 or the device 500, the web server 12 issues (generates) a command to be transmitted to the mediating apparatus 30 or the device 500. The issued command is a control command such as acquisition of status information indicating the status of the device 500 or power on or power off. These commands are examples of request information indicating a predetermined request for the device 500. The web server 12 may have a function such as WebSocket to display the command result received by the mediating apparatus communication unit 11 on the screen of the web client 91 in real time. The web server 12 is implemented by, for example, a program executed by the CPU 1001 illustrated in FIG. 4.

The storage/readout unit 13 stores various data in the storage unit 200 and reads the various data from the storage unit 200. The storage/readout unit 13 and the storage unit 200 are implemented by, for example, a program executed by the CPU 1001 illustrated in FIG. 4. The storage unit 200 is implemented by the ROM 1002 or the storage 1004 illustrated in FIG. 4. Furthermore, the storage unit 200 stores a device management table 150a that stores and manages various information related to the device 500 to be managed by the remote device management apparatus 10. Details of the device management table 150a are described below.

Hereinafter, a functional configuration of the administrator terminal 90 is described. The functions implemented by the administrator terminal 90 illustrated in FIG. 5 include the web client 91 and a reception unit 92.

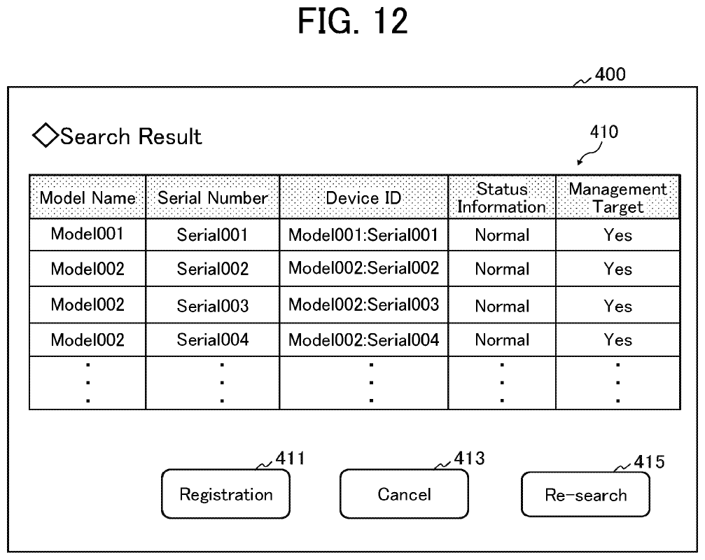

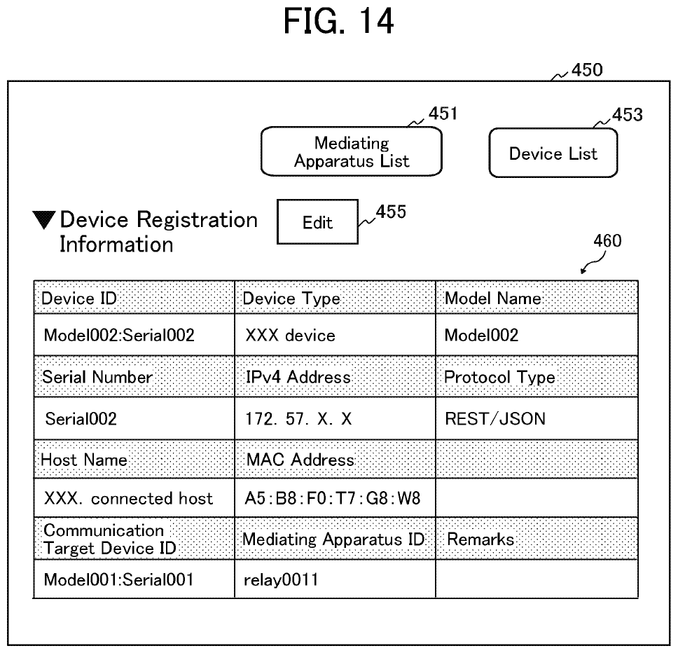

The web client 91 is a client unit of the web application. The web client 91 is implemented by executing a program described in a language such as HyperText Markup Language (HTML), JavaScript (registered trademark), or Cascading Style Sheets (CSS) operating in a web browser. The web client 91 displays, for example, a device search result display screen 400 (see FIG. 12) and a registered device display screen 450 (see FIG. 14), which is described below, on the display 1006a of the administrator terminal 90. The web client 91 is implemented by, for example, a program executed by the network I/F 1008 and the CPU 1001 illustrated in FIG. 4. The web client 91 is an example of a display control unit.

The reception unit 92 accepts user input to the input device such as the keyboard 1005 illustrated in FIG. 4. The reception unit 92 receives, for example, a selection of various items illustrated on the display screen displayed on the display 1006a by the web client 91.

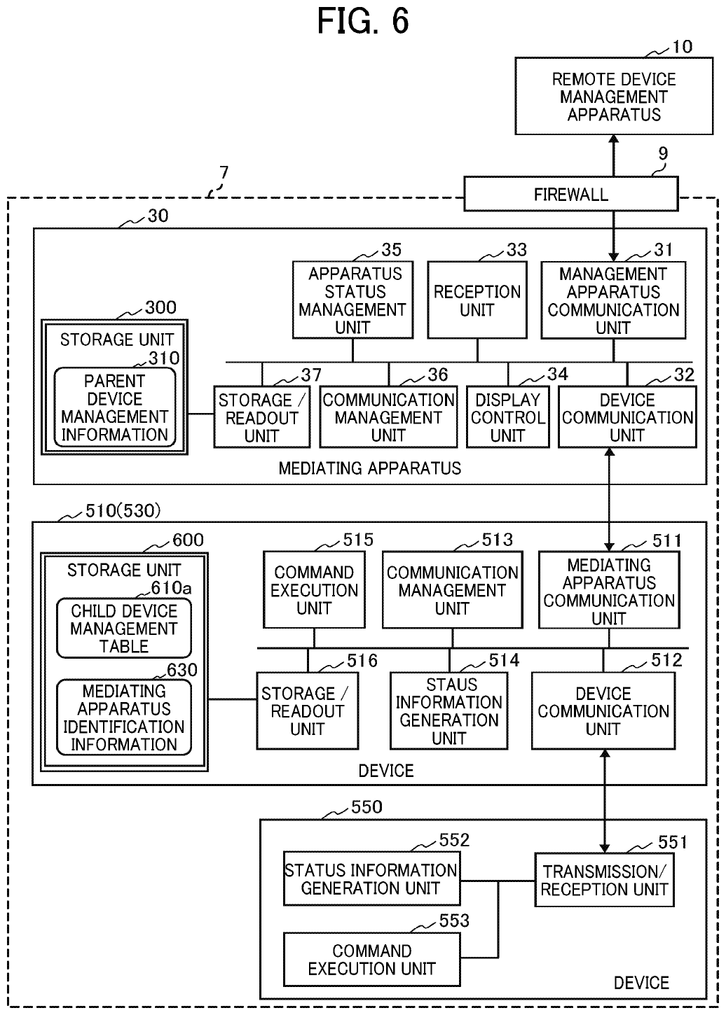

Functional configurations of the devices included in the local network 7 are described with reference to FIG. 6.

FIG. 6 is a block diagram illustrating an example of the functional configuration of the mediating apparatus and the device according to the first embodiment of the present disclosure. The functions implemented by the mediating apparatus 30 illustrated in FIG. 6 include a management apparatus communication unit 31, a device communication unit 32, a reception unit 33, a display control unit 34, an apparatus status management unit 35, a communication management unit 36, the storage/readout unit 37, and a storage unit 300.

The management apparatus communication unit 31 exchanges various data with the remote device management apparatus 10. The management apparatus communication unit 31 receives, for example, a command transmitted from the remote device management apparatus 10 that requests the device 500 to execute a predetermined process. In addition, the management apparatus communication unit 31 transmits, for example, a response (execution result of processing) to the command transmitted from the remote device management apparatus 10 to the remote device management apparatus 10. Furthermore, the management apparatus communication unit 31 transmits, to the remote device management apparatus 10, the status information indicating the status of the mediating apparatus 30 or the device 500, which has been sent from the mediating apparatus 30. The management apparatus communication unit 31 is implemented by, for example, a program executed by the network I/F 1008 and the CPU 1001 illustrated in FIG. 4.

The device communication unit 32 exchanges data with the device 500. The device communication unit 32 communicates with the device 500 using an operation type, a communication protocol, and parameters managed by the communication management unit 36. The device communication unit 32 transmits, for example, the command received by the management apparatus communication unit 31 to the device 500. Further, the device communication unit 32 receives, for example, a response to the command transmitted from the device 500. The device communication unit 32 is implemented by, for example, a network I/F 1008 and a program executed by the CPU 1001 illustrated in FIG. 4.

The reception unit 33 receives input by a user to the input device such as the keyboard 1005 illustrated in FIG. 4. The display control unit 34 causes the display 1006a illustrated in FIG. 4 to display various screen information. The display control unit 34 causes the display 1006a to display, for example, an operation window for receiving an input by the user. The display screen displayed by the display control unit 34 is, for example, a user interface (UI) for performing settings necessary for installing the mediating apparatus 30 on the local network 7. The mediating apparatus 30 uses the UI displayed by the display control unit 34 to set Internet Protocol (IP) address for network communication, parameters such as subnet mask or default gateway, Uniform Resource Locator (URL) of the remote device management apparatus 10, proxy server (authentication server), and the like. In addition, the mediating apparatus 30 confirms connection with the remote device management apparatus 10 and starts communication by using the UI displayed by the display control unit 34. The display control unit 34 is implemented by, for example, a program executed by the CPU 1001 illustrated in FIG. 4.

The apparatus status management unit 35 manages status of resources of the mediating apparatus 30. The apparatus status management unit 35 detects, for example, a symptom of a failure (malfunction) such as a memory shortage of the mediating apparatus 30, a storage shortage, or a write error. In addition, the apparatus status management unit 35 periodically generates status information including resource state monitoring results based on, for example, a preset schedule. The apparatus status management unit 35 is implemented by, for example, a program or the like executed by the CPU 1001 illustrated in FIG. 4.

The communication management unit 36 manages a communication definition for communicating with the device 500 included in the local network 7. The communication management unit 36 manages, for example, the operation type, communication protocol, and parameters used for communication with the device 500. For example, the operation type includes acquisition of an identifier (serial number) of the device 500, acquisition of status information of the device 500, confirmation of connection with the remote device management apparatus 10, addition or deletion of the device 500 to be managed (monitored), and the like. The communication protocol includes HTTP, SNMP, Internet Control Message Protocol (ICMP) or the like. The parameter includes a timeout time or retry count as parameters common to each communication protocol, method, resource Uniform Resource Identifier (URI), header, or body as HTTP specific parameters, object identifier (CAD), version, command type, or community name as SNMP specific parameters. The communication management unit 36 manages the communication definition for communicating with the device 510 capable of directly communicating with the mediating apparatus 30 and the device 550 subordinate to the device 510. The communication management unit 36 is implemented by, for example, a program or the like executed by the CPU 1001 illustrated in FIG. 4.

The storage/readout unit 37 stores various data in the storage unit 300 and reads various data from the storage unit 300. The storage/readout unit 37 and the storage unit 300 are implemented by, for example, a program executed by the ROM 1002, the storage 1004, and the CPU 1001 illustrated in FIG. 4. The storage unit 300 stores parent device management information 310 which is information on the device 510 (parent device) that can communicate with the mediating apparatus 30. Details of the parent device management information 310 is described below.

A functional configuration of the device 510 is described below. The device 510 (530) illustrated in FIG. 6 is a device under which another device exists among the plurality of hierarchical devices 500, and in addition to the device 510, for example, the device 530b and the device 530c illustrated in FIG. 3 are also included. The device 510 (530) illustrated in FIG. 6 is an example of a first device. The functions implemented by the device 510 illustrated in FIG. 6 include a mediating apparatus communication unit 511, a device communication unit 512, a communication management unit 513, a status information generation unit 514, a command execution unit 515, a storage/readout unit 516 and a storage unit 600.

The mediating apparatus communication unit 511 exchanges data with the mediating apparatus 30. The mediating apparatus communication unit 511 communicates with the mediating apparatus 30 using a communication protocol such as HTTP or SNMP. The mediating apparatus communication unit 511 is implemented by, for example, a network I/F 1008 and a program executed by the CPU 1001 illustrated in FIG. 4.

The device communication unit 512 exchanges data with another device 500. The device communication unit 512 communicates with, for example, the device 500 (child device) belonging to its subordinate. In the example illustrated in FIG. 2, the device communication unit 512 of the device 510 communicates with the devices 550a to 550c, and in the example illustrated in FIG. 3, the device communication unit 512 of the device 510 communicates with the devices 530a to 530c. Any communication method may be used by the device communication unit 512, for example, TCP/IP communication or serial communication.

In addition to the device 500 belonging to the subordinate, the device communication unit 512 also communicates with the device of the upper tier when the device 500 is also present in the upper tier. For example, in the example of FIG. 3, the device communication unit 512 of the device 530b communicates with the device 510 of the upper tier (first tier) and communicates with the device 550a of the subordinate (third tier). The device communication unit 512 of the device 530c communicates with the device 510 of the upper tier (first tier) and with the devices 550b and 550c of the subordinate (third tier). In such a case, the device communication unit 512 transmits a notification such as status information indicating the status of the device itself and the devices of the subordinate to the device 510 of the upper tier. The device communication unit 512 is implemented by, for example, the network I/F 1008 and a program executed by the CPU 1001 illustrated in FIG. 4.

The communication management unit 513 manages communication with the mediating apparatus 30 and the device 550 belonging to the subordinate. The communication management unit 513 performs, for example, status management of the own device and status management of the subordinate device 550. The communication management unit 513 is implemented by, for example, a program executed by the CPU 1001 illustrated in FIG. 4.

The status information generation unit 514 generates status information indicating the status of the device 510. The status information is, for example, log information including information indicating the resource status of the device 510 and information on the operating state. The status information generation unit 514 generates the status information to be transmitted to the mediating apparatus 30 in response to a request from the mediating apparatus 30. The status information generation unit 514 is implemented by, for example, a program executed by the CPU 1001 illustrated in FIG. 4.

The command execution unit 515 executes a command which is an instruction to begin a process to the device 500 issued by the remote device management apparatus 10. The command is, for example, a control instruction such as acquisition of the status information indicating the status of the device 500 or on/off of the power. The command execution unit 515 is implemented by, for example, a program executed by the CPU 1001 illustrated in FIG. 4.

The storage/readout unit 516 stores various data in the storage unit 600 and reads the various data from the storage unit 600. The storage/readout unit 516 and the storage unit 600 are implemented by, for example, the ROM 1002, the storage 1004, and a program executed by the CPU 1001 illustrated in FIG. 4. The storage unit 600 stores a child device management table 610a that stores and manages information related to the devices 500 (child devices) of the subordinate, and mediating apparatus identification information 630 for identifying the mediating apparatus 30. The mediating apparatus identification information 630 is, for example, the IP address of the mediating apparatus 30.

A functional configuration of the device 550 is described below. The device 550 illustrated in FIG. 6 is a device located at the lowest tier among the plurality of devices 500 in a hierarchical structure, and includes, in addition to the device 550, the device 530a illustrated in FIG. 3, for example. The device 550 (530) illustrated in FIG. 6 is an example of a second device. The functions implemented by the device 550 illustrated in FIG. 6 include a transmission/reception unit 551, a status information generation unit 552, and a command execution unit 553.

The transmission/reception unit 551 exchanges data with another device 500. The transmission/reception unit 551 communicates with, for example, the device 510 (530) belonging to the upper tier. In the example illustrated in FIG. 2, the transmission/reception unit 551 of the device 550a communicates with the device 510. Further, in the example illustrated in FIG. 3, the transmission/reception unit 551 of the device 550a communicates with the device 530b. Any communication method may be used by the transmission/reception unit 551, for example, TCP/IP communication or serial communication.

The status information generation unit 552 generates status information indicating a status of the device 550. The status information is log information including information indicating the resource status of the device 550 and information regarding the operating state. The status information generation unit 552 generates status information to be transmitted to the mediating apparatus 30 in response to a request from the mediating apparatus 30. The status information generation unit 552 is implemented by, for example, a program executed by the CPU 1001 illustrated in FIG. 4.

The command execution unit 553 executes a command which is an instruction to begin a process to the device 500 issued by the remote device management apparatus 10. The command is, for example, a control instruction such as acquisition of the status information indicating the status of the device 500 or on/off of the power. The command execution unit 553 is implemented by, for example, a program executed by the CPU 1001 illustrated in FIG. 4.

### Communication Definition

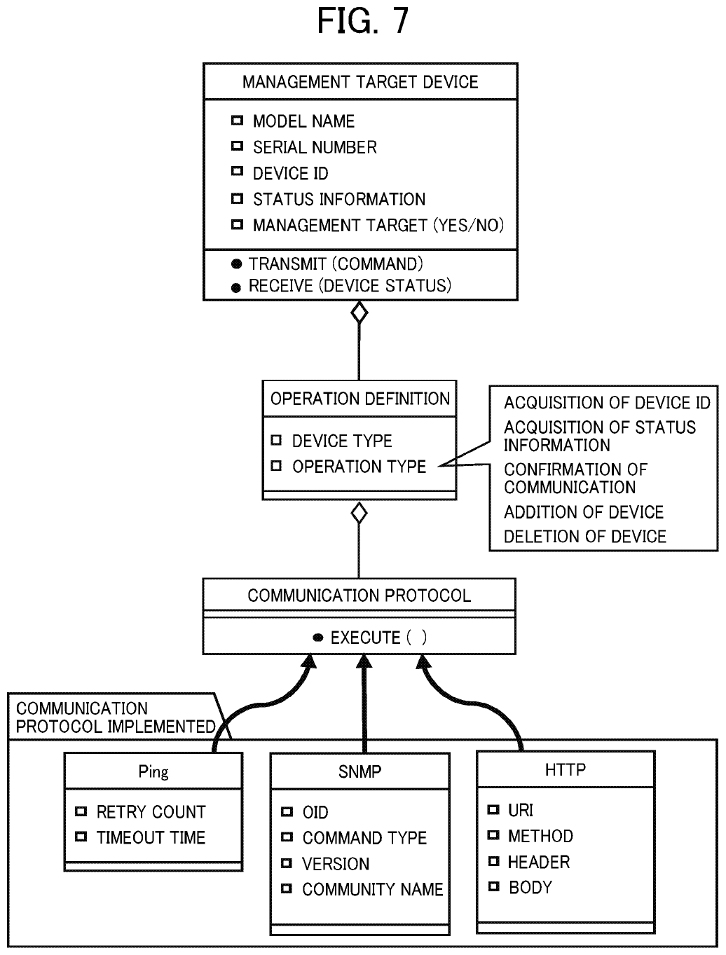

A communication definition used for communication from a device 500 is described with reference to FIG. 7. FIG. 7 is a diagram illustrating an example of a schematic model of the communication definition of the device according to the first embodiment of the present disclosure. The device 500 (management target device) which is a monitoring target (management target) of the remote device management apparatus 10 transmits a model name indicating a type of the device 500, a serial number which is a device identifier (ID) of the device 500, a device identifier for identifying the device 500, status information indicating the status of the device 500, and management target information indicating whether the remote device management apparatus 10 manages the device 500. The remote device management apparatus 10 can identify the device 500 using the model name and the serial number transmitted from the device 500. The device ID also includes a model name and a serial number, but is information different from the model name and the serial number, such that the device 500 may be identified using the device ID.

The device 500 (management target device) has a plurality of operation types for each device type as an operation definition. The operation type is, for example, acquisition of the device identifier (serial number) of the device 500, acquisition of status information, confirmation of communication with the mediating apparatus 30, and addition or deletion of the device 500 to be managed.

Furthermore, each operation type is composed of a plurality of communication protocols. The communication protocols that can be used in the device 500 are standard protocols such as ICMP (Ping), SNMP, or HTTP (body part is Java (registered trademark) Script Object Notation (JSON)), and each communication protocol is used for one exchange of communication. That is, the device 500 can be configured to perform multiple times of communication for one operation type. The parameters include, for example, a timeout time and a retry count as parameters common, and include a method, a resource URI, a header, a body, and the like as HTTP-specific parameters. The SNMP-specific parameters include, for example, OID, version, command type (Get/GetBulk), community name, and the like.

The device 500 communicates with the mediating apparatus 30 and the remote device management apparatus 10 using the communication definition illustrated in FIG. 7. In the remote device management system 1, each device 500 can be identified by the remote device management apparatus 10 even when the devices 500 belonging to the local network 7 have a hierarchical relation (parent-child relation) as illustrated in FIG. 2 and FIG. 3.

Device Management Table

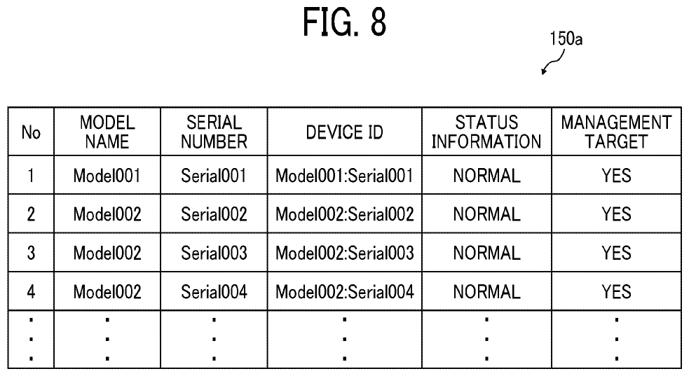

FIG. 8 is a diagram illustrating an example of a device management table according to the first embodiment of the present disclosure. The device management table 150a is stored and managed in the storage unit 200 of the remote device management apparatus 10. The device management table 150a stores various information on the device 500 to be managed (monitored) by the remote device management apparatus 10.

The device management table 150a stores the model name, the serial number, the device ID, the status information, and the management target information indicating whether or not a device is a management target. The remote device management apparatus 10 can identify the device 500 using the model name and the serial number included in the device management table 150a. The device ID includes the model name and the serial number. The device ID may be different from the model name and the serial number, and the mediating apparatus 30 may be configured to identify the device 500 using the device ID. The model name and the serial number and the device ID are both examples of the device identification information. The device identification information for identifying the device 500 is not limited thereto, and may be, for example, a Media Access Control (MAC) address of the device 500 or a device name. Furthermore, the remote device management apparatus 10 monitors (manages) the status of the device 500 based on the status information and the management target information associated with the device identification information. The device management table 150a is an example of device management information.

Parent Device Management Information

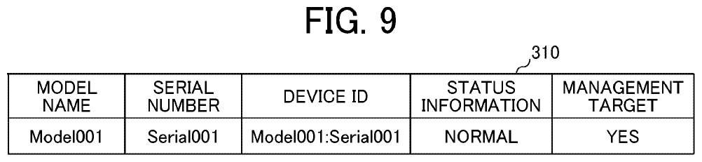

FIG. 9 is a diagram illustrating an example of parent device management information according to the first embodiment of the present disclosure. The parent device management information 310 is information stored in the storage unit 300 of the mediating apparatus 30. The parent device management information 310 is device information related to the device 510 (parent device) that can communicate with the mediating apparatus 30. The items included in the parent device management information 310 are the same as the items of the device management table 150a described above. The device identification information for identifying the device 510 (parent device) that can communicate with the mediating apparatus 30 is an example of first device identification information.

Child Device Management Table

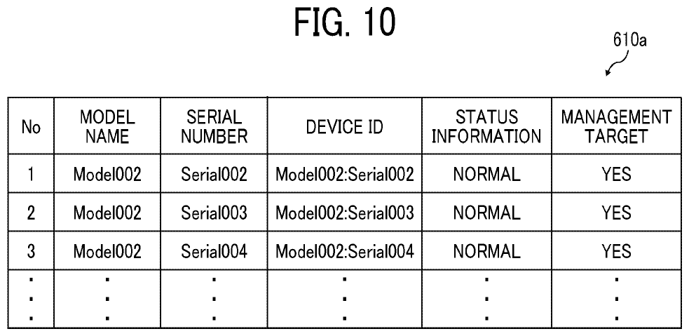

FIG. 10 is a diagram illustrating an example of a child device management table according to the first embodiment of the present disclosure. The child device management table 610a is stored and managed in the storage unit 600 of the device 510 (or device 530) which functions as a parent device. The child device management table 610a stores, for each device 500 (child device), device information related to the device 500 (child device) subordinate to the device 510 (parent device). The items included in the device information of each device 500 (child device) stored in the child device management table 610a are the same as the device management table 150a and the parent device management information 310 described above. The device identification information for identifying the device 500 (child device) subordinate to the device 510 (parent device) is an example of second device identification information.

Process and Operation of First Embodiment: Device Registration Process

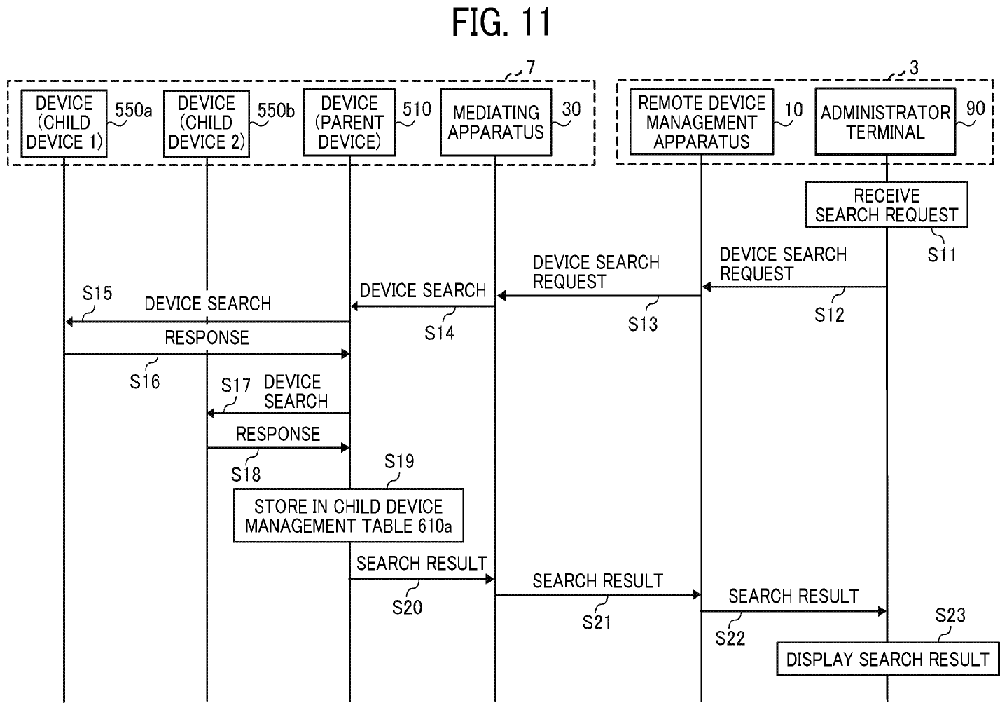

A process of registering the device 500 to be managed by the remote device management apparatus 10 in the remote device management system 1 is described with reference to FIG. 11 to FIG. 15.

First, a process of searching the device 500 to be managed by the remote device management apparatus 10 is described using FIG. 11. FIG. 11 is a sequence diagram illustrating an example of a device search process executed by the remote device management system according to the first embodiment of the present disclosure. FIG. 11 illustrates, for example, a process using a display screen displayed by the web client 91 using the web application provided by the web server 12.

In step S11, the reception unit 92 of the administrator terminal 90 receives a search request for the device 500 by the user's input operation on a setting screen displayed on the display 1006a by the web client 91.

In step S12, the web client 91 of the administrator terminal 90 transmits the search request accepted by the reception unit 92 to the remote device management apparatus 10. The web server 12 of the remote device management apparatus 10 receives a search request for the device 500. In step S13, the mediating apparatus communication unit 11 of the remote device management apparatus 10 transmits the search request received by the web server 12 to the mediating apparatus 30. Then, the management apparatus communication unit 31 of the mediating apparatus 30 receives the search request. In step S14, the device communication unit 32 of the mediating apparatus 30 transmits a search request to the parent device 510. Specifically, when the management apparatus communication unit 31 receives a search request, the storage/readout unit 37 reads the parent device management information 310 stored in the storage unit 300. The device communication unit 32 transmits a search request to the device 510 identified by the device identification information indicated in the parent device management information 310. Then, the mediating apparatus communication unit 511 of the device 510 receives, from the mediating apparatus 30, the search request transmitted from the remote device management apparatus 10 to the mediating apparatus 30.

The device 510 that has received the search request transmits the search request to the devices 500 subordinate to the device 510. Here, the device 510 transmits the search request to the device 550a and the device 550b. First, in step S15, the device communication unit 512 of the device 510 transmits the search request to the device 550a, and in step S16, in response to the search request, the transmission/reception unit 551 of the device 550a transmits a response to the search request to the device 510. Here, the response to the search request is transmitted according to the communication definition illustrated in FIG. 7. In response to the search request, a model name indicating the type of the device 550a, a serial number that is an identifier of the device 550a, a device ID for identifying the device 550a, status information indicating the status of the device 550a, and management target information indicating whether the device 550a is a management target of the remote device management apparatus 10 are included. Note that the response to the search request may not necessarily include the status information and the management target information. Furthermore, in step S17, the device communication unit 512 of the device 510 transmits a search request to the device 550b and in step S18, in response to the search request, the transmission/reception unit 551 of the device 550a transmits a response to the search request to the device 510. Thereby, the device communication unit 512 of the device 510 receives the response to the search request transmitted from the device 550a and the device 550b. Note that the order of the process of step S15 to step S16 and the processes of step S17 to step S18 may be reversed or may be performed in parallel.

In step S19, the storage/readout unit 516 of the device 510 stores the device information on the device 550 that has transmitted the response in the child device management table 610a stored in the storage unit 600. Thus, the device 510 stores and manages device information regarding the device 550 (child device) subordinate to the device 510. When the device 510 stores the device information on the device 550 (child device) in advance, the device search need not be performed, and in this case, the processes of steps S15 to S18 may be omitted.

In step S20, the mediating apparatus communication unit 511 of the device 510 transmits information indicating the search result of the device 500 to the mediating apparatus 30. The information indicating the search result of the device 500 includes the device information on the device 550 (child device) and the device information on the device 510 (parent device) stored in the child device management table 610a. Here, the device information may include device identification information indicating at least the model name and serial number of the device 500, or the device ID and the like. Then, the device communication unit 32 of the mediating apparatus 30 receives the information indicating the search result of the device 500. In step S21, the management apparatus communication unit 31 of the mediating apparatus 30 transmits to the remote device management apparatus 10, information indicating the search result of the device 500 received by the device communication unit 32. Then, the mediating apparatus communication unit 11 of the remote device management apparatus 10 receives the information indicating the search result of the device 500. In step S22, the web server 12 of the remote device management apparatus 10 transmits to the administrator terminal 90, information indicating the search result of the device 500 received by the mediating apparatus communication unit 11. Then, the web client 91 of the administrator terminal 90 receives the information indicating the search result of the device 500.

In step S23, the web client 91 of the administrator terminal 90 displays the device search result display screen 400 including the received information indicating the search result of the device 500 on the display 1006a. FIG. 12 is a diagram illustrating an example of a device search result display screen displayed on the management system according to the first embodiment of the present disclosure. In the device search result display screen 400 illustrated in FIG. 12, a device registration candidate display area 410 in which the search result of the device 500 is displayed in a list, a registration button 411 pressed when registering the device 500 displayed in the device registration candidate display area 410, a cancel button 880 to be pressed when canceling the registration process, and a re-search button 415, which is pressed when the device 500 is to be re-searched are included.

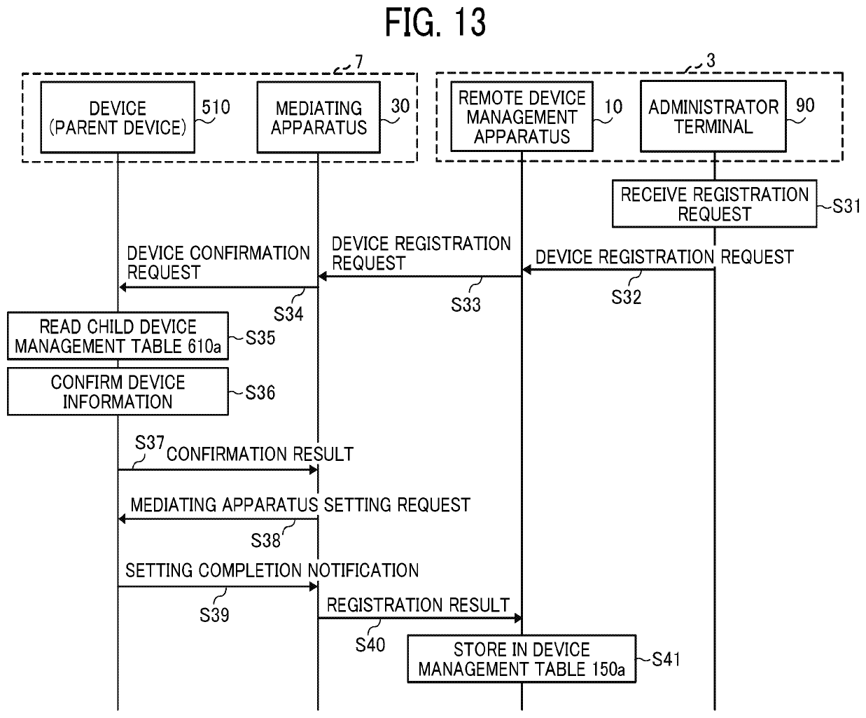

Subsequently, a process of registering the device information on the device 500 in the remote device management apparatus 10 using the search result obtained by the above-described device search process is described. FIG. 13 is a sequence diagram illustrating an example of a device information registration process executed by the remote device management system according to the first embodiment of the present disclosure. FIG. 13 illustrates an example in which registration process of device information is started using the device search result display screen 400 illustrated in FIG. 12.

In step S31, the reception unit 92 receives an input operation on the registration button 411 included in the device search result display screen 400 displayed on the display 1006a by the web client 91, thereby receiving a device registration request.

In step S32, the web client 91 of the administrator terminal 90 transmits a device registration request to the remote device management apparatus 10. Here, the device registration request includes device identification information such as the model name and serial number of the device 500 to be registered or the device ID. Then, the web server 12 of the remote device management apparatus 10 receives the device registration request. In step S33, the mediating apparatus communication unit 11 of the remote device management apparatus 10 transmits the device registration request received by the web server 12 to the mediating apparatus 30. Then, the management apparatus communication unit 31 of the mediating apparatus 30 receives the device registration request.

In step S34, the device communication unit 32 of the mediating apparatus 30 transmits a device confirmation request to the parent device 510. Here, the device confirmation request is transmitted, for example, to confirm whether the model name and serial number (or the device ID) of the device 500 to be registered are correct. This is because when time has passed from search to registration, the IP address may be changed and there is a possibility that the device 500 to be registered is no longer a target to be managed (monitored). Specifically, when the management apparatus communication unit 31 receives the device registration request, the storage/readout unit 37 of the mediating apparatus 30 reads the parent device management information 310 stored in the storage unit 300. Then, the device communication unit 32 transmits a device confirmation request to the device 510 identified by the device identification information indicated in the parent device management information 310. Then, the mediating apparatus communication unit 511 of the device 510 receives the device confirmation request.

In step S35, when the mediating apparatus communication unit 511 receives the device confirmation request, the storage/readout unit 516 of the device 510 reads the child device management table 610a stored in the storage unit 600. In step S36, the communication management unit 513 of the device 510 confirms whether the device identification information included in the device confirmation request is included in the child device management table 610a read by the storage/readout unit 516. In step S37, the device communication unit 512 of the device 510 transmits information on the confirmation result obtained by the communication management unit 513 to the mediating apparatus 30. For example, when the device identification information included in the device confirmation request is included in the child device management table 610a, the device communication unit 512 transmits information indicating that effect to the mediating apparatus 30. On the other hand, when the device identification information included in the device confirmation request is not included in the child device management table 610a, for example, the device communication unit 512 transmits information indicating that the target device for the device confirmation request does not exist to the mediating apparatus 30, and the remote device management apparatus 10 notifies that there is no device 500 to be registered. Hereinafter, an example in the case where the device identification information included in the device confirmation request is included in the child device management table 610a is described. Then, the device communication unit 32 of the mediating apparatus 30 receives the confirmation result.

In step S38, the device communication unit 32 of the mediating apparatus 30 transmits a setting request for the mediating apparatus 30 to the device 510. Here, the setting request includes the mediating apparatus identification information 630 for identifying the mediating apparatus 30. The mediating apparatus identification information 630 is, for example, the IP address of the mediating apparatus 30. Then, the mediating apparatus communication unit 511 of the device 510 receives the setting request of the mediating apparatus 30. In step S39, the mediating apparatus communication unit 511 of the device 510 transmits a setting completion notification of the mediating apparatus 30 to the mediating apparatus 30. Specifically, when the setting request of the mediating apparatus 30 is received by the mediating apparatus communication unit 511, the storage/readout unit 516 of the device 510 causes the storage unit 600 to store the mediating apparatus identification information 630. When the mediating apparatus identification information 630 is stored, the mediating apparatus communication unit 511 transmits a setting completion notification to the mediating apparatus 30. As a result, when an occurrence of a malfunction is reported from a child device such as the device 550a subordinate to the device 510 (parent device), the notification is transmitted to the mediating apparatus 30. In addition, when notification from the child device to the mediating apparatus 30 is not necessary, the processes of step S38 and step S39 may be omitted.

In step S40, the management apparatus communication unit 31 of the mediating apparatus 30 transmits the registration result of the device 500 to the remote device management apparatus 10. Then, the mediating apparatus communication unit 11 of the remote device management apparatus 10 receives the registration result of the device 500. In step S41, the storage/readout unit 13 of the remote device management apparatus 10 stores the device information of the registered device 500 in the device management table 150a stored in the storage unit 200.

Thereby, the remote device management system 1 can register the device information on the devices 500 included in the local network 7 with the remote device management apparatus 10 regardless of the hierarchical relation between the devices 500. In addition, the administrator terminal 90 presents information on the device 500 to be managed to the administrator by causing the web client 91 to display the registered device display screen 450 including the device information registered in the remote device management apparatus 10.

FIG. 14 is a diagram illustrating an example of a registered device display screen displayed on the management system according to the first embodiment of the present disclosure. The registered device display screen 450 illustrated in FIG. 14 is a screen created based on the device information included in the device management table 150a of the remote device management apparatus 10. The registered device display screen 450 displays a device registration information display area 460 in which device information related to the registered device 500 is displayed, a mediating apparatus list button 451 that is pressed when displaying a list of mediating apparatus 30 that can communicate with the remote device management apparatus 10, a device list button 453 that is pressed when displaying a list of registered devices 500, and an edit button that is pressed when editing device information related to the registered device 500.

The device registration information display area 460 includes a device ID, a device type, a model name, a serial number, an IPv4 address, a protocol type, a host name, a MAC address, a mediating apparatus ID, and the like. Further, as described in a second embodiment and a third embodiment described below, when the device management table 150 includes the parent device ID, the device registration information display area 460 includes a communication target device ID indicating a parent device ID as illustrated in FIG. 14. In the case of a configuration in which such a hierarchical relation of the device 500 is managed by the remote device management apparatus 10, in order to make the hierarchical relation of the device 500 more intuitive, the hierarchical relation of the devices 500 may be displayed as a conceptual model diagram indicating network topology.

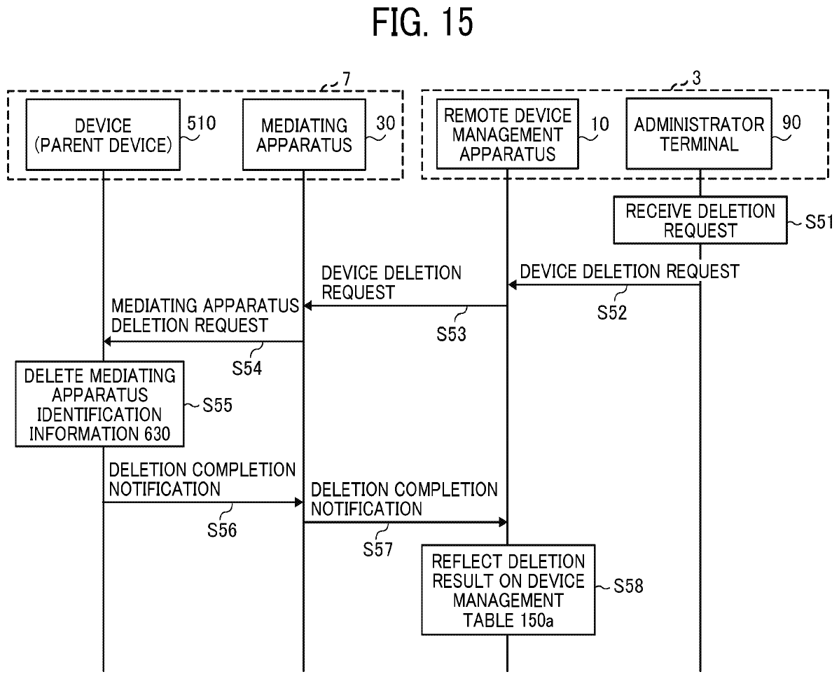

Hereinafter, a process of deleting the device information registered by the above-described device registration process is described. FIG. 15 is a sequence diagram illustrating an example of a device registration information deletion process executed by the remote device management system according to the first embodiment of the present disclosure. FIG. 15 illustrates an example in which deletion process of device information is started using the registered device display screen 450 illustrated in FIG. 14.

In step S51, the reception unit 92 of the administrator terminal 90 receives the input operation on the edit button 455 included in the registered device display screen 450 displayed on the display 1006a by the web client 91, thereby requesting deletion of a device 500.

In step S52, the web client 91 of the administrator terminal 90 transmits the device deletion request for the device 500 received by the reception unit 92 to the remote device management apparatus 10. Here, the device deletion request includes device identification information such as the model name and serial number of the device 500 to be deleted, or the device ID. Then, the web server 12 of the remote device management apparatus 10 receives the device deletion request. In step S53, the mediating apparatus communication unit 11 of the remote device management apparatus 10 transmits the device deletion request received by the web server 12 to the mediating apparatus 30. Then, the management apparatus communication unit 31 of the mediating apparatus 30 receives the device deletion request.

In step S54, the device communication unit 32 of the mediating apparatus 30 transmits a deletion request for the mediating apparatus 30 to the parent device 510. Specifically, when the deletion request for the mediating apparatus 30 is received by the management apparatus communication unit 31, the storage/readout unit 37 reads the parent device management information 310 stored in the storage unit 300. Then, the device communication unit 32 transmits the deletion request for the mediating apparatus 30 to the device 510 indicated by the parent device management information 310.

In step S55, the communication management unit 513 of the device 510 deletes the mediating apparatus identification information 630 stored in the storage unit 600. In step S56, the mediating apparatus communication unit 51 of the device 510 transmits to the mediating apparatus 30, a deletion completion notification indicating that the information of the mediating apparatus 30 is deleted. Then, the device communication unit 32 of the mediating apparatus 30 receives the deletion completion notification. In step S57, the management apparatus communication unit 31 of the mediating apparatus 30 transmits the deletion completion notification as a response to the device deletion request to the remote device management apparatus 10. Then, the mediating apparatus communication unit 11 of the remote device management apparatus 10 receives the deletion completion notification.

In step S58, the storage/readout unit 13 of the remote device management apparatus 10 reflects the deletion result on the device management table 150a based on the deletion completion notification received by the mediating apparatus communication unit 11. Specifically, the storage/readout unit 13 deletes the device information on the device 500 to be deleted from the device management table 150a.

When the mediating apparatus identification information 630 is not stored in the device 510 because the device 500 does not voluntarily notify the mediating apparatus 30 (for example, the process from step S38 to step S39 in FIG. 13 is omitted) steps S53 to S57 may be omitted. In addition, when there is a device 500 not to be deleted besides the device 500 to be deleted under the parent device 510, the mediating apparatus identification information 630 is required for status notification from the device 500 not to be deleted. Therefore, the deletion process (step S55) of the mediating apparatus identification information 630 is not performed.

Communication Between Remote Device Management Apparatus and Device

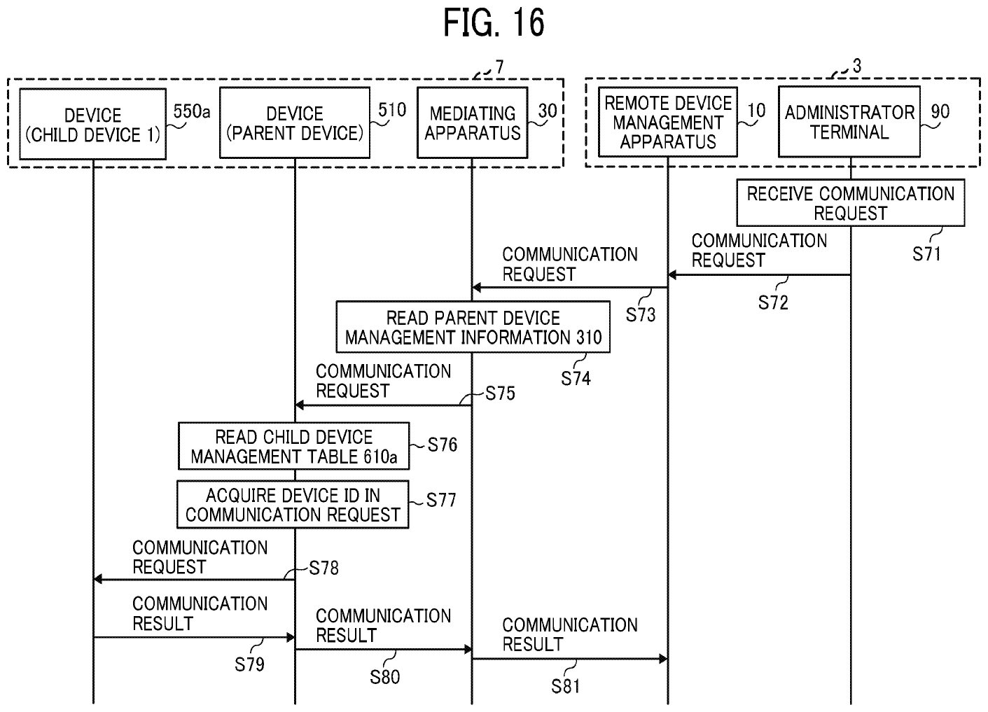

Communication between the remote device management apparatus and the device 500 based on the device information registered in the device registration process illustrated in FIGS. 11 to 15 is described with reference to FIGS. 16 to 18. First, communication process according to a communication request from the remote device management apparatus 10 to the device 500 is described with reference to FIG. 16. FIG. 16 is a sequence diagram illustrating an example of communication from the remote device management apparatus to the device in the remote device management system according to the first embodiment of the present disclosure. Although FIG. 16 illustrates an example in which the remote device management apparatus 10 makes a communication request to the device 550a, the same process is performed for a communication request to another device 500. Here, the communication request for the device 550 from the remote device management apparatus 10 is an example of request information indicating a request for a particular second device.

In step S71, the reception unit 92 of the administrator terminal 90 receives a communication request for the device 500 by an input operation on a setting screen displayed on the display 1006a by the web client 91. The reception unit 92 receives a communication request for a particular device 500, for example, by designating device identification information such as the device ID of the device 500 to be communicated. In the example illustrated in FIG. 16, the reception unit 92 receives a communication request in which the device ID of the device 550a is designated.

In step S72, the web client 91 of the administrator terminal 90 transmits a communication request for the device 550a to the remote device management apparatus 10. The communication request includes the device ID of the device 500 to be communicated, or device identification information such as a model name and a serial number. Here, the communication request includes the device ID of the device 550a. Then, the web server 12 of the remote device management apparatus 10 receives a communication request to the device 550a. In step S73, the mediating apparatus communication unit 11 of the remote device management apparatus 10 transmits the communication request for the device 550a received by the web server 12 to the mediating apparatus 30. Here, the remote device management apparatus 10 transmits a communication request to the mediating apparatus 30 included in the local network 7 to which the device 550a belongs. Since the device management table 150a is managed for each mediating apparatus 30, the remote device management apparatus 10 can identify the mediating apparatus 30 from the device information on the device 550a. Then, the management apparatus communication unit 31 of the mediating apparatus 30 receives the communication request for the device 550a.

In step S74, the storage/readout unit 37 of the mediating apparatus 30 reads the parent device management information 310 stored in the storage unit 300. In step S75, the device communication unit 32 of the mediating apparatus 30 transmits a communication request to the device 550a to the device 510 identified by the device identification information indicated by the parent device management information 310. Then, the mediating apparatus communication unit 511 of the device 510 receives the communication request to the device 550a.

In step S76, when the communication request to the device 550a is received, the storage/readout unit 516 of the device 510 reads the child device management table 610a stored in the storage unit 300. In step S77, the communication management unit 513 of the device 510 acquires the corresponding device ID included in the child device management table 610a using the device ID included in the communication request received by the mediating apparatus communication unit 511. As a result, the device 510 confirms that the device 500 that is a transmission destination of the communication request transmitted from the mediating apparatus 30 is a device (child device) subordinate to the own device. In this case, the communication management unit 513 confirms that the device ID of the device 550a is included in the child device management table 610a.

In step S78, the device communication unit 512 of the device 510 transmits a communication request to the device 550a. Then, the transmission/reception unit 551 of the device 550a receives the communication request. In step S79, the transmission/reception unit 551 of the device 550a transmits to the device 510, information on the communication result as a response to the received communication request. Then, the device communication unit 512 of the device 510 receives the information on the communication result transmitted from the device 550a.

In step S80, the mediating apparatus communication unit 511 of the device 510 transmits the information of the communication result received by the device communication unit 512 to the mediating apparatus 30, and the device communication unit 32 of the mediating apparatus 30 receives the information of the communication result. Then, in step S81, the management apparatus communication unit 31 of the mediating apparatus 30 transmits the information on the communication result received by the device communication unit 32 to the remote device management apparatus 10. Then, the mediating apparatus communication unit 11 of the remote device management apparatus 10 receives, from the mediating apparatus 30, information on the communication result as a response to the transmitted communication request.

As a result, the remote device management apparatus 10 designates the device ID (an example of the device identification information) of the device 500 to be communicated among the devices 500 stored and managed in the device management table 150a and communicates with the designated device 500 through the mediating apparatus 30. Also, when it is desired to transmit a communication request to multiple devices 500 at a time, the administrator terminal 90 can transmit the communication requests to a plurality of devices 500 all at once by receiving a plurality of device IDs. Thus, the remote device management system 1 can improve the responsiveness of the display screen displayed by the web client 91 of the management system 3 and can reduce the time required for communication, by reducing the number of times of communication.

Acquisition of Device Information

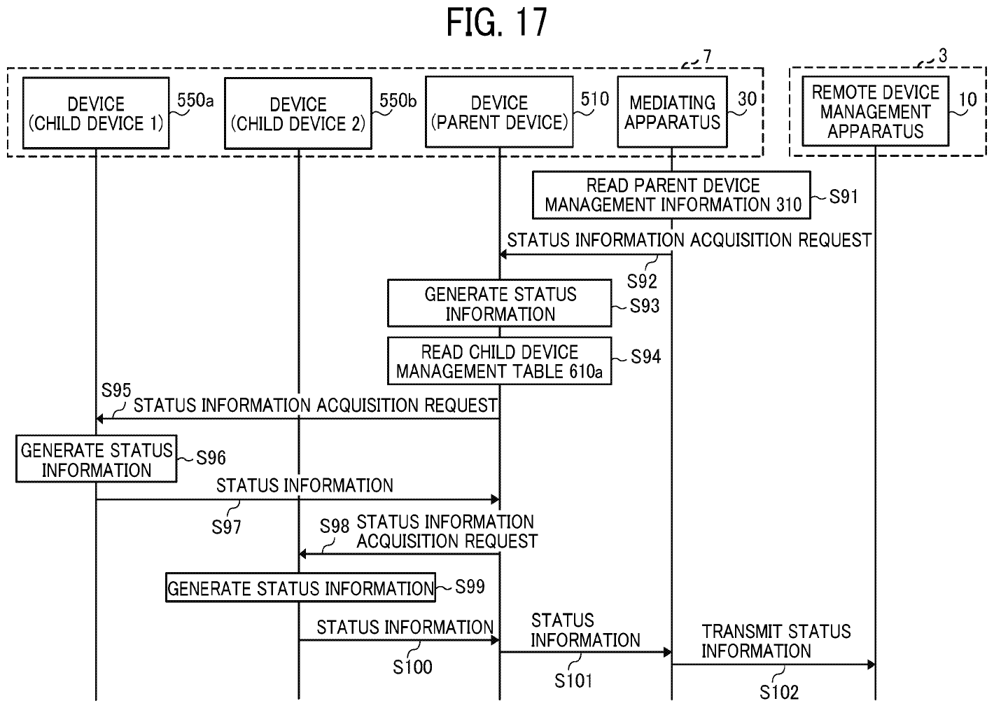

A process for acquiring status information of the device 500 in response to a request from the mediating apparatus 30 is described with reference to FIG. 17. FIG. 17 is a sequence diagram illustrating an example of a device information acquisition process executed by the remote device management system according to the first embodiment of the present disclosure. FIG. 17 illustrates a process in the case where the mediating apparatus 30 acquires the status information of the device 500 and notifies the remote device management apparatus 10 of the acquired information at a time designated by periodic execution of the mediating apparatus 30 or at regular intervals. Although FIG. 17 illustrates an example of acquiring the status information of the device 550a and the device 550b, the same process is performed when acquiring the status information of another device 500.

In step S91, the storage/readout unit 37 of the mediating apparatus 30 reads the parent device management information 310 stored in the storage unit 300. In step S92, the device communication unit 32 of the mediating apparatus 30 transmits an acquisition request for status information to the device 510 identified by the device identification information indicated by the parent device management information 310. Then, the mediating apparatus communication unit 511 of the device 510 receives the acquisition request for the status information.

In step S93, the status information generation unit 514 of the device 510 generates status information indicating the status of the device 510. The status information is, for example, log information including information indicating the resource status of the device 510 and information on the operating state. When the device 510 acts only as a relay device for relaying communication with the device 500 (child device) under the control of the own device (when it is not a device to be managed), the process of step S93 may be omitted.

In step S94, the storage/readout unit 516 of the device 510 reads the child device management table 610a stored in the storage unit 600. Then, the communication management unit 513 of the device 510 extracts the device 500 identified by the device identification information indicated in the read child device management table 610a. In the case of the child device management table 610a illustrated in FIG. 10, the communication management unit 513 extracts the device 500 identified by the device IDs “Model 002: Serial 002”, “Model 002: Serial 003”, and “Model 002: Serial 002”. Here, the communication management unit 513 extracts the device 550a and the device 550b.

In step S95, the device communication unit 512 of the device 510 transmits an acquisition request for status information to the device 550a extracted by the communication management unit 513. Then, the transmission/reception unit 551 of the device 550a receives the acquisition request for the status information. In step S96, the status information generation unit 552 of the device 550a generates status information of the device 550a. In step S97, the transmission/reception unit 551 of the device 550a transmits the status information generated by the status information generation unit 552 to the device 510. Then, the device communication unit 512 of the device 510 receives the status information of the device 550a.

In step S98, the device communication unit 512 of the device 510 transmits an acquisition request for status information to the device 550b extracted by the communication management unit 513. Then, the transmission/reception unit 551 of the device 550b receives the acquisition request for the status information. In step S99, the status information generation unit 552 of the device 550b generates status information of the device 550b. In step S100, the transmission/reception unit 551 of the device 550b transmits the status information generated by the status information generation unit 552 to the device 510. Then, the device communication unit 512 of the device 510 receives the status information of the device 550b. The order of the process of step S95 to step S97 and the process of step S98 to step S100 may be reversed or may be performed in parallel.

In step S101, the mediating apparatus communication unit 511 of the device 510 transmits the status information of the device 510 generated by the status information generation unit 514 and the status information of the device 550a and the status information of the device 550b received by the device communication unit 512 to the mediating apparatus 30. Here, when there are many dozens of devices 500 (child devices) under the device 510 (parent device), it takes a lot of time to query each device separately. Therefore, device 510 (parent device) inquires to subordinate device 500 (child device) in parallel processing, and when the status confirmations of multiple devices 500 are acquired, by collectively transmitting status information of a plurality of devices 500 (child devices) from the device 510 to the mediating apparatus 30, processing load can be reduced. Then, the device communication unit 32 of the mediating apparatus 30 receives the status information transmitted from the device 510.

In Step S102, the Management Apparatus Communication Unit 31 of the mediating apparatus 30 transmits the status information received by the device communication unit 32 to the remote device management apparatus 10. Then, the mediating apparatus communication unit 11 of the remote device management apparatus 10 receives the status information transmitted from the mediating apparatus 30. Thus, the mediating apparatus 30 can acquire the status information of the device 550 subordinate to the device 510 by transmitting an acquisition request for the status information of the device 550 (child device) subordinate to the device 510 to the device 510 functioning as the parent device. Also, the remote device management apparatus 10 that has received the status information of the device 550 (child device) from the mediating apparatus 30 can notify the administrator of the status of the device 550a by displaying the received status information using the web client 91.

Notification of Device Status

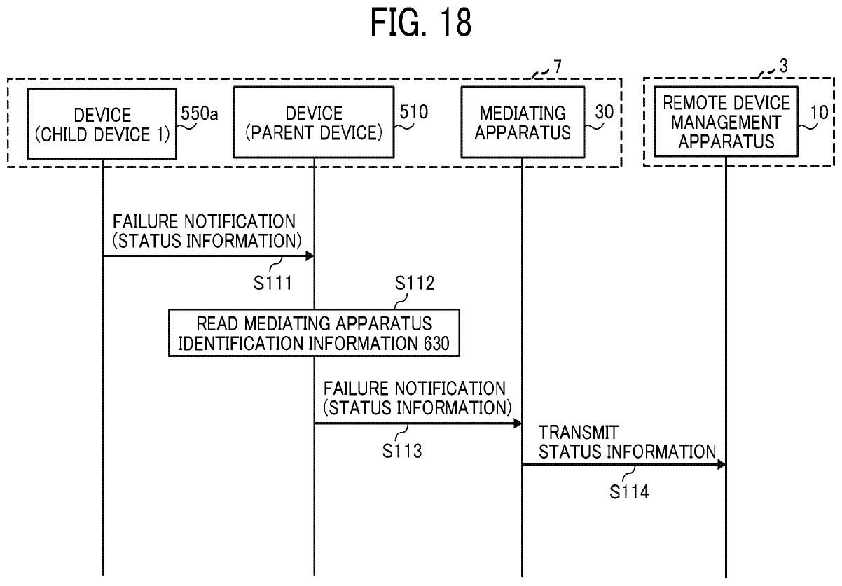

A notification process of the device status information from the device 500 is described using FIG. 18. FIG. 18 is a sequence diagram illustrating an example of a device status notification process from the device to the remote device management apparatus by the remote device management system according to the first embodiment of the present disclosure. Although FIG. 18 illustrates an example of the case where the status information is transmitted from the device 550a, the same process is performed when the status information is transmitted from another device 500.

In step S111, the transmission/reception unit 551 of the device 550a transmits status information such as a failure notification to the device 510. Specifically, the status information generation unit 552 of the device 550a generates status information of the device 550a when a malfunction such as a failure occurs in the device 550a. The transmission/reception unit 551 of the device 550a transmits the status information generated by the status information generation unit 552 to the device 510. Then, the device communication unit 512 of the device 510 receives the status information transmitted from the device 550a.

In step S112, the storage/readout unit 516 of the device 510 reads the mediating apparatus identification information 630 stored in the storage unit 600. In step S113, the mediating apparatus communication unit 511 of the device 510 transmits the status information of the device 550a to the mediating apparatus 30 identified by the mediating apparatus identification information 630 read by the storage/readout unit 516. Then, the device communication unit 32 of the mediating apparatus 30 receives the status information of the device 550a.

In step S114, the management apparatus communication unit 31 of the mediating apparatus 30 transmits the status information of the device 550a received by the device communication unit 32 to the remote device management apparatus 10. Then, the mediating apparatus communication unit 11 of the remote device management apparatus 10 receives the status information of the device 550a. As a result, the remote device management apparatus 10 can receive the status information voluntarily transmitted from the device 550a (child device) present in the local network 7, the remote device management apparatus 10 can detect the occurrence of a malfunction such as a failure of the device 550a (child device) that cannot communicate directly with the mediating apparatus 30.

Although FIG. 18 illustrates an example in which the device 550a (child device) voluntarily notifies the status information, when the device 550a (child device) does not have this function, the device 510 (parent device) periodically queries the device 550a (child device). Then, when a malfunction such as a failure is detected by the response to the inquiry, the device 510 (parent device) notifies the remote device management apparatus 10 of the status information of the device 550a through the mediating apparatus 30.

### Effect of First Embodiment

As described above, the remote device management system according to the first embodiment holds the child device management table 610 in which the device 510 (parent device) stores and manages device information of the device 550 (child device). Then, when the device 510 (parent device) receives a device search request from the mediating apparatus 30, the device 510 transmits its own device information and the device information of the child device to the management system 3 by transmitting the device information to the mediating apparatus 30. Then, the management system 3 displays a list of the received device information. Thus, in the remote device management system according to the first embodiment, even when there is device 550 (child device) that cannot communicate with the mediating apparatus 30 in the local network 7, the management system 3 can manage the device 550 (child device).

### Second Embodiment

A remote device management system according to the second embodiment is now described. The same configurations and the same functions as those of the first embodiment are denoted by the same reference numbers, and the description thereof is omitted. The remote device management system according to the second embodiment includes a plurality of devices 500 capable of directly communicating with the mediating apparatus 30.

Overview

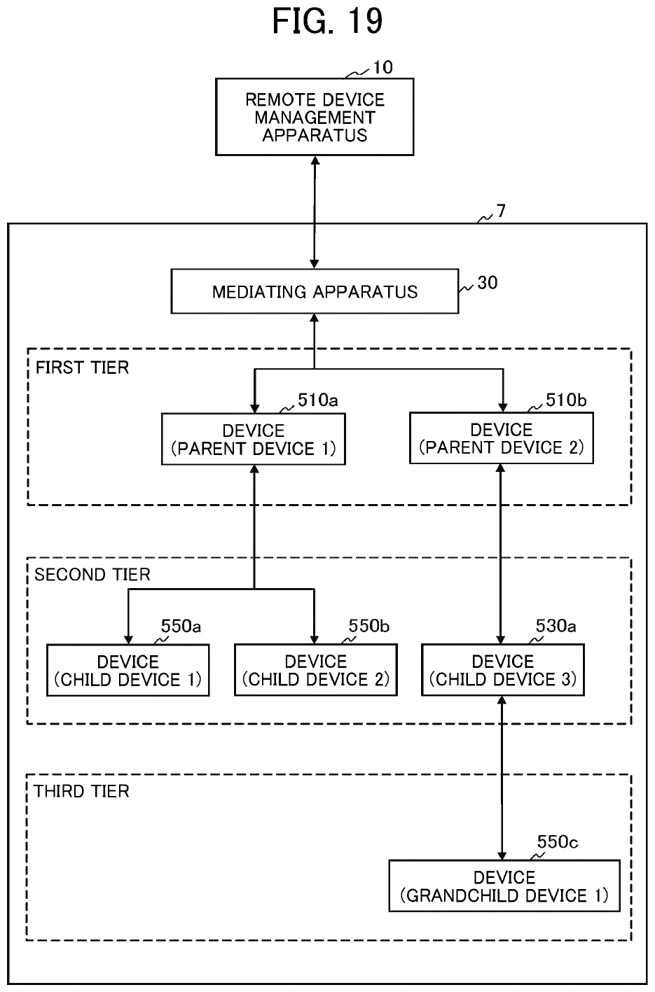

FIG. 19 is a diagram illustrating an example of an overview of the remote device management system according to the second embodiment of the present disclosure. The remote device management system 1 illustrated in FIG. 19 includes a plurality of devices (devices 510a and 510b) of a first tier that can directly communicate with the mediating apparatus 30. A device 550a and a device 550b of a second tier exist under the device 510a of the first tier. The device 510a (parent device) communicates with the device 550a (child device) and the device 550b (child device) in the local network 7. Further, a device 530a of the second tier is subordinate to the device 510b of the first tier. The device 510 b (parent device) communicates with the device 530a (child device) in the local network 7. Furthermore, in the subordinate of the device 530a of the second tier, a device 550c of a third tier exists. The device 530a (parent device) communicates with the device 550c in the local network 7.

Communication Definition

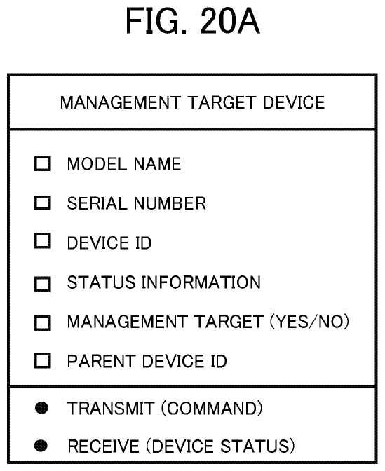

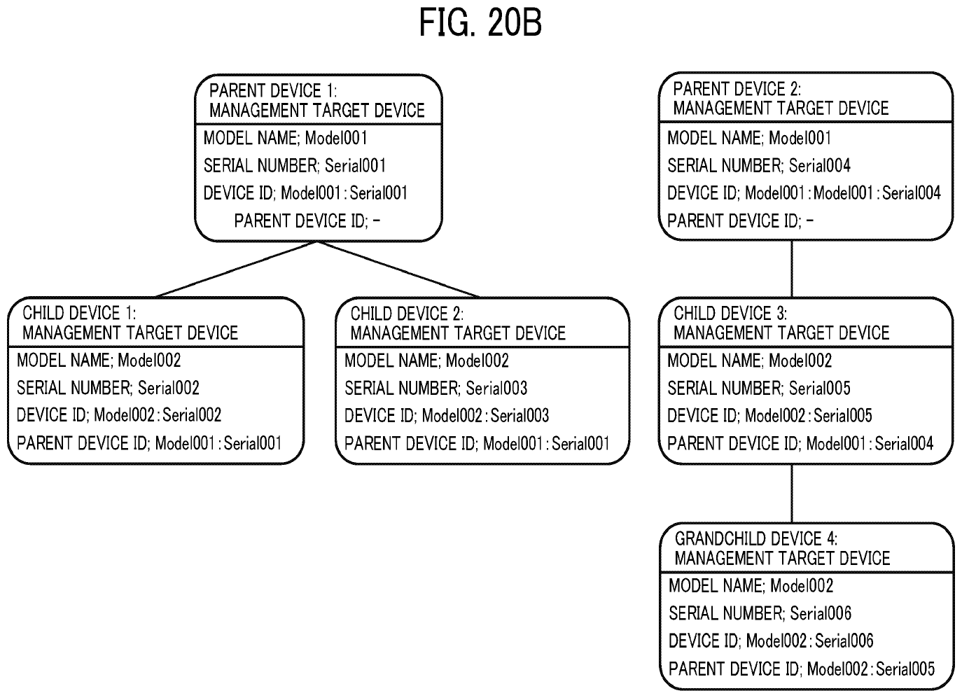

FIG. 20A and FIG. 20B are diagrams illustrating examples of a schematic model of the communication definition of the device according to the second embodiment of the present disclosure. The operation definition and the communication protocol are the same as the communication definition of the first embodiment illustrated in FIG. 7, and the description thereof is omitted. As illustrated in FIG. 20A, the device 500 (management target device) which is a management target (monitoring target) of the remote device management apparatus 10, transmits the parent device ID for identifying the device 500 to be the parent device belonging to the upper tier of the own device, in addition to the information listed in FIG. 7. Also, FIG. 20B schematically illustrates information transmitted from each device 500 based on the hierarchical relation of the devices 500 illustrated in FIG. 19. As illustrated in FIG. 20B, the device 500 (management target device) has a data structure that can have only one parent device ID to identify the device 500 that functions as a parent device belonging to upper hierarchy. In the parent device 1 and the parent device 2 that can directly communicate with the mediating apparatus 30, there is no device 500 belonging to the upper hierarchy, so the field of the parent device ID is blank.

Device Management Table

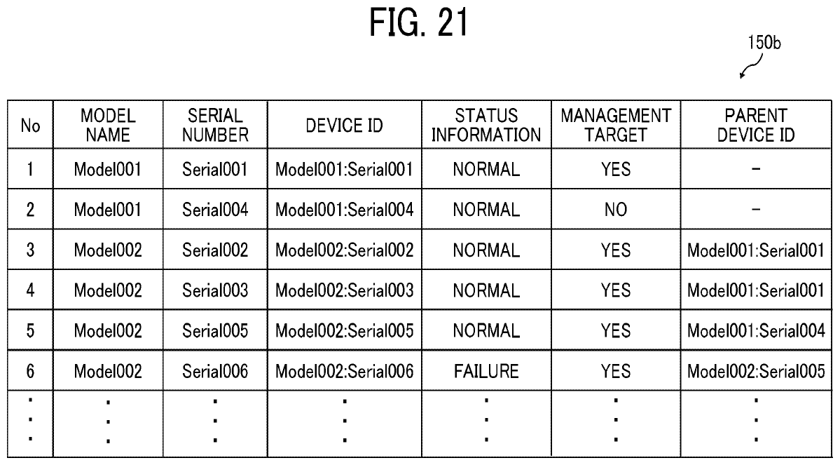

FIG. 21 is a diagram illustrating an example of a device management table according to the second embodiment of the present disclosure. The storage unit 200 of the remote device management apparatus 10 according to the second embodiment stores a device management table 150b instead of the device management table 150a illustrated in FIG. 8. The device management table 150b includes in addition to the device information on a device 500 to be managed (monitored) by the remote device management apparatus 10 included in the device management table 150a, a parent device ID for designating a device 500 to be a parent device belonging to a higher tier, in association with each other. The device management table 150b is an example of device management information. The remote device management apparatus 10 detects hierarchical relation (parent-child relation) of the device 500 under management by storing and managing the device identification information for identifying the device 500 in association with the parent device ID for identifying the parent device of the device 500.

Parent Device Management Table

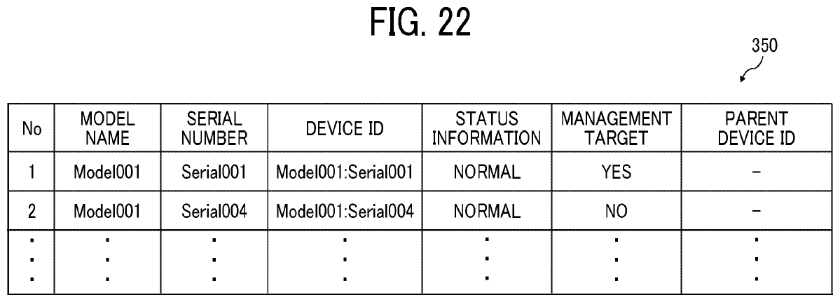

FIG. 22 is a diagram illustrating an example of a parent device management table according to the second embodiment of the present disclosure. The storage unit 300 of the mediating apparatus 30 according to the second embodiment stores a parent device management table 350 in place of the parent device management information 310 illustrated in FIG. 9. The parent device management table 350 manages device information (parent device management information 310) regarding a plurality of devices 500 (parent devices) that can communicate with the mediating apparatus 30. The items included in the device information (parent device management information 310) regarding the plurality of devices 500 illustrated in the parent device management table 350 are the same as the device management table 150b described above.

Child Device Management Table

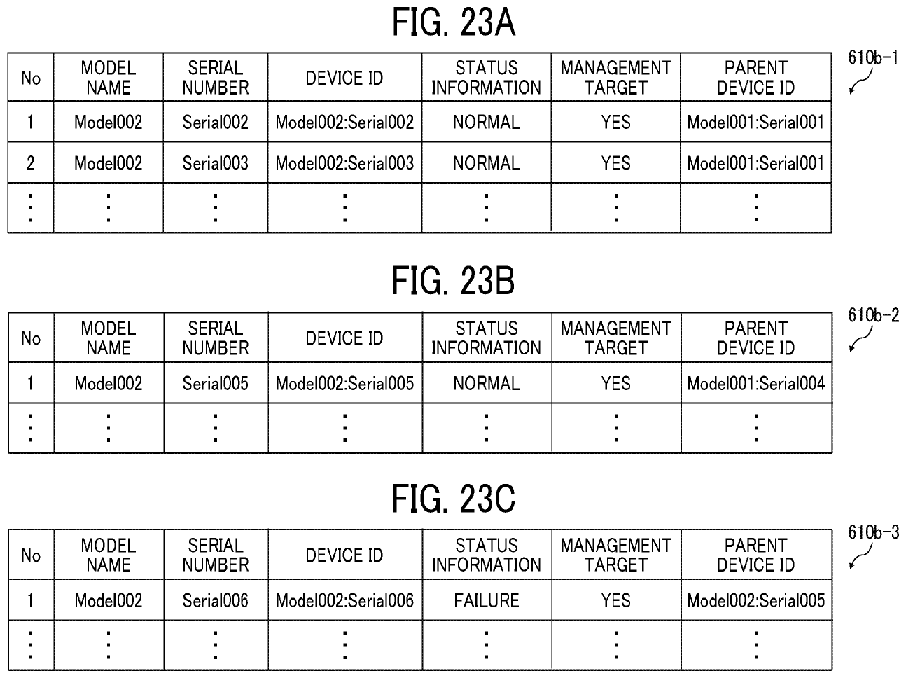

FIGS. 23A, 23B, and 23C are diagrams illustrating examples of child device management tables according to the second embodiment of the present disclosure. The storage unit 600 of the device 510 according to the second embodiment stores the child device management table 610b instead of the child device management table 610a. In the child device management table 610b, the device information included in the child device management table 610a is stored in association with a parent device ID for identifying the device 500 as a parent device belonging to the upper tier of the own device. FIG. 23A is a child device management table 610b-1 stored and managed in the parent device 1 illustrated in FIG. 20, FIG. 23B is a child device management table 610b-2 stored and managed in the parent device 2 illustrated in FIG. 20, and FIG. 23C is a child device management table 610b-3 stored and managed by the child device 3 illustrated in FIG. 20.

Process and Operation of Second Embodiment Communication Between Remote Device Management Apparatus and Device

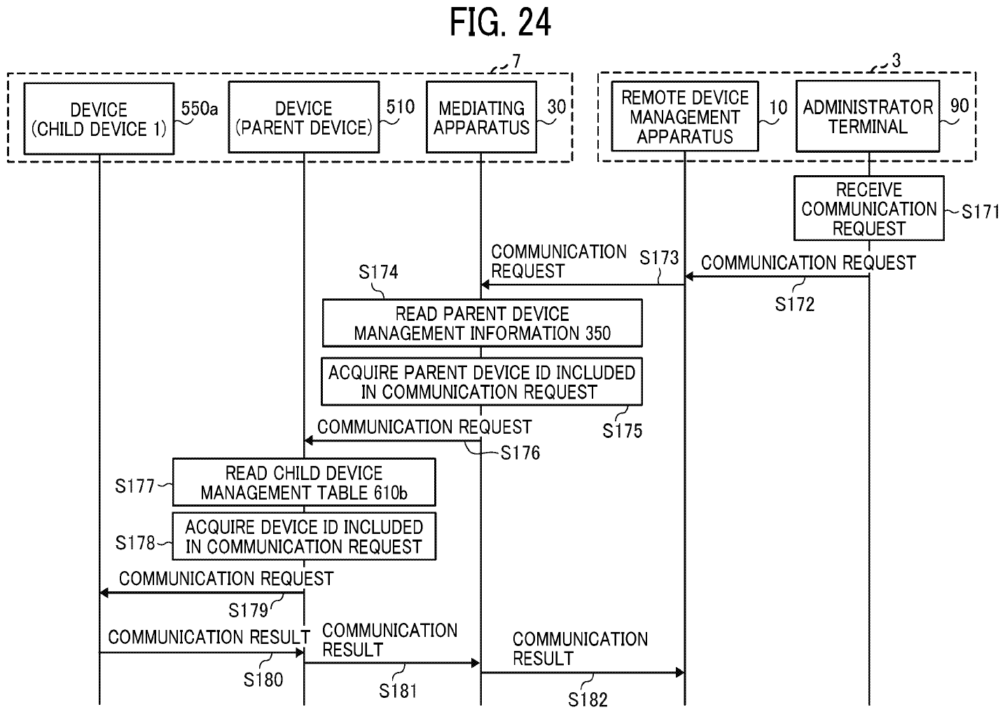

Hereinafter, processing and operation of the remote device management system according to the second embodiment is described. Except for the content registered in each device illustrated in FIG. 21 to FIG. 23, the registration process of the device 500 to be managed by the remote device management apparatus 10 is the same as the processing illustrated in FIG. 11 to FIG. 15, and the description thereof is omitted. Hereinafter, communication processing according to a communication request from the remote device management apparatus 10 to the device 500 in the second embodiment is described with reference to FIG. 24.

FIG. 24 is a sequence diagram illustrating an example of communication from the remote device management apparatus to the device by the remote device management system according to the second embodiment of the present disclosure. FIG. 24 illustrates an example in which the remote device management apparatus 10 issues a communication request to the device 550a, but the same processing is performed for a communication request to another device 500.

In step S171, the reception unit 92 of the administrator terminal 90 receives a communication request of the device 500 by an input operation on a setting screen displayed on the display 1006a by the web client 91. The reception unit 92 receives a communication request for a particular device 500, for example, by designating device identification information such as the device ID of the device 500 to be communicated. In the example illustrated in FIG. 24, the reception unit 92 receives a communication request in which the device ID of the device 550a is designated.

In step S172, the web client 91 of the administrator terminal 90 transmits a communication request for the device 550a to the remote device management apparatus 10. The communication request includes device identification information such as the device ID of the device 500 to which communication is addressed, and the parent device ID associated with the device 500 to be communicated in the device management table 150b. Here, the communication request includes the device ID of the device 550a and the device ID of the device 510 as a parent device ID. Then, the web server 12 of the remote device management apparatus 10 receives the communication request to the device 550a. In step S173, the mediating apparatus communication unit 11 of the remote device management apparatus 10 transmits, to the mediating apparatus 30, the communication request for the device 550a received by the web server 12. Here, the remote device management apparatus 10 transmits a communication request to the mediating apparatus 30 included in the local network 7 to which the device 550a belongs. Since the device management table 150c is managed for each mediating apparatus 30, the remote device management apparatus 10 can identify the mediating apparatus 30 from the device information on the device 550a. Then, the management apparatus communication unit 31 of the mediating apparatus 30 receives the communication request for the device 550a.

In step S174, the storage/readout unit 37 of the mediating apparatus 30 reads the parent device management table 350 stored in the storage unit 300. In step S175, the communication management unit 36 of the mediating apparatus 30 acquires the parent device ID included in the parent device management table 350 using the parent device ID included in the communication request received by the management apparatus communication unit 31. Thereby, the mediating apparatus 30 identifies the device 510 (parent device) which is the transmission destination of the communication request among the plurality of devices 500 that can directly communicate from the mediating apparatus 30. In step S176, the device communication unit 32 of the mediating apparatus 30 transmits a communication request addressed to the device 550a to the device 510 identified by the parent device ID acquired by the communication management unit 36. Then, the mediating apparatus communication unit 511 of the device 510 receives the communication request addressed to the device 550a.

In step S177, when the communication request to the device 550a is received, the storage/readout unit 516 of the device 510 reads the child device management table 610b stored in the storage unit 300. In step S178, the communication management unit 513 of the device 510 acquires the corresponding device ID included in the child device management table 610b using the device ID included in the communication request received by the mediating apparatus communication unit 511 as a search key. As a result, the device 510 confirms that the device 500 that is a transmission destination of the communication request transmitted from the mediating apparatus 30 is a device (child device) subordinate to the own device. In this case, the communication management unit 513 confirms that the device ID of the device 550a is included in the child device management table 610b.

In step S179, the device communication unit 512 of the device 510 transmits the communication request addressed to the device 550a to the device 550a. Then, the transmission/reception unit 551 of the device 550a receives the communication request. In step S180, the transmission/reception unit 551 of the device 550a transmits to the device 510, information on the communication result as a response to the received communication request. Then, the device communication unit 512 of the device 510 receives the information on the communication result transmitted from the device 550a.

In step S181, the mediating apparatus communication unit 511 of the device 510 transmits the information on the communication result received by the device communication unit 512 to the mediating apparatus 30, and the device communication unit 32 of the mediating apparatus 30 receives the information on the communication result. Then, in step S182, the management apparatus communication unit 31 of the mediating apparatus 30 transmits the information on the communication result received by the device communication unit 32 to the remote device management apparatus 10. Then, the mediating apparatus communication unit 11 of the remote device management apparatus 10 receives, from the mediating apparatus 30, the information on the communication result as a response to the transmitted communication request.

Thus, in the remote device management apparatus 10 according to the second embodiment, even when there are a plurality of devices 510 (parent devices) that can directly communicate with the mediating apparatus 30 included in the local network 7, the remote device management apparatus 10 based on the parent device ID (an example of first device identification information) for identifying the device 510 (parent device), communication can be performed with the device 550a (child device) subordinate to the device 510 through the identified device 510.

Moreover, in the acquisition process of status information of the device 500 from the mediating apparatus 30 according to the second embodiment, in step S91 illustrated in FIG. 17, the mediating apparatus 30 selects one of the plurality of parent devices identified by the plurality of pieces of device identification information included in the parent device management table 350, and the parent device belonging to the upper tier of the device 500 to which the acquisition request for the status information is to be transmitted is identified. Then, in step S92, the device communication unit 32 of the mediating apparatus 30 transmits an acquisition request for status information to the identified parent device. Thus, in the remote device management system according to the second embodiment, even when there are a plurality of parent devices which the mediating apparatus 30 can directly communicate, a parent device for transmitting the acquisition request for status information to a particular child device can be identified. Since the process after step S92 illustrated in FIG. 17 is the same, the description is omitted.

### Effect of Second Embodiment

As described above, in the remote device management system according to the second embodiment, when there are a plurality of devices 510 (parent devices) capable of directly communicating with the mediating apparatus 30 in the local network 7, based on the parent device ID (an example of first device identification information) for identifying the device 510 (parent device), the remote device management apparatus 10 communicates with the device 550 (child device) through the device 510 functioning as the parent device. As a result, in the remote device management system according to the second embodiment, even when there are a plurality of devices 510 (parent devices) capable of directly communicating with the mediating apparatus 30 in the local network 7, the management system 3 can manage the device 550 (child device).

### Third Embodiment

Hereinafter, the remote device management system according to a third embodiment is described. The same configuration and function as those of the first embodiment or the second embodiment are denoted by the same reference numbers, and the description thereof will be omitted. The remote device management system according to the third embodiment is a system in which a device 500 functioning as a child device can communicate with a plurality of parent devices.

Overview

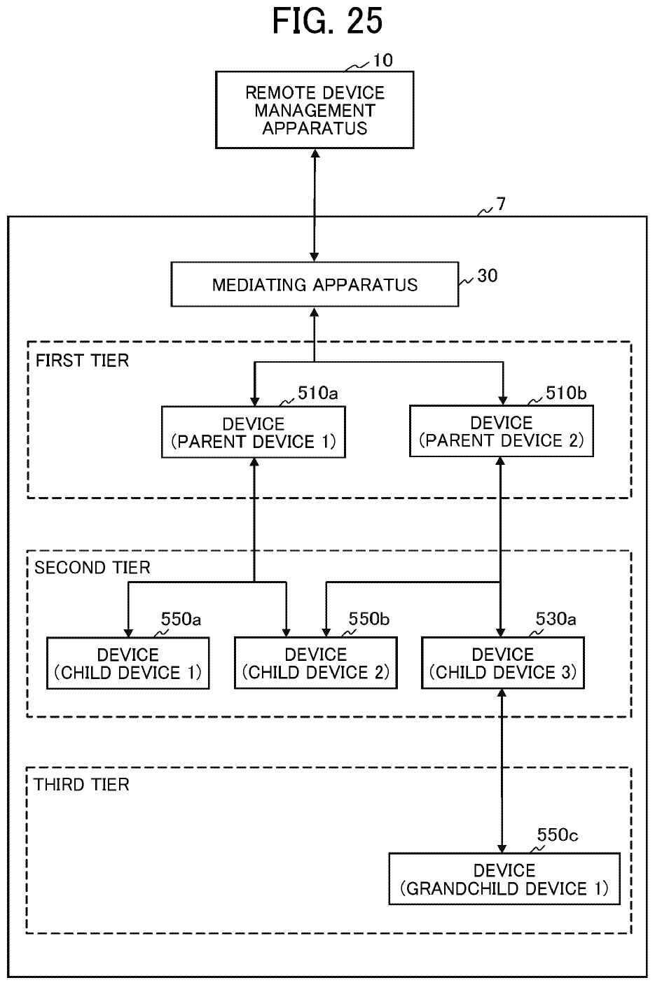

FIG. 25 is a diagram illustrating an example of an overview of the remote device management system according to a third embodiment of the present disclosure. The remote device management system illustrated in FIG. 25 has a hierarchical relation in which the device 550b of the second tier can communicate with the devices 510a and 510b of the first tier. Since the device 550b can communicate with both the device 510a and the device 510b, even if one of the device 510a and the device 510b becomes unusable due to a failure or the like, remote device management such as sending a notification to the remote device management apparatus 10 can be performed using the other device 500.

Communication Definition

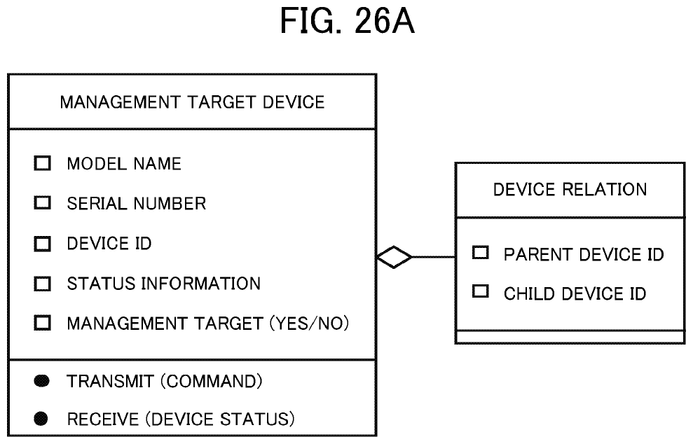

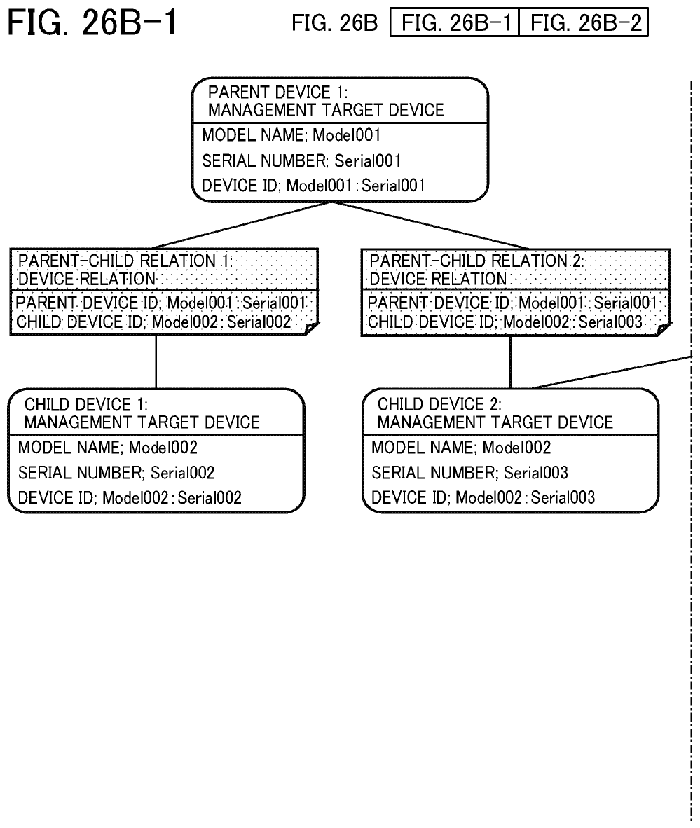

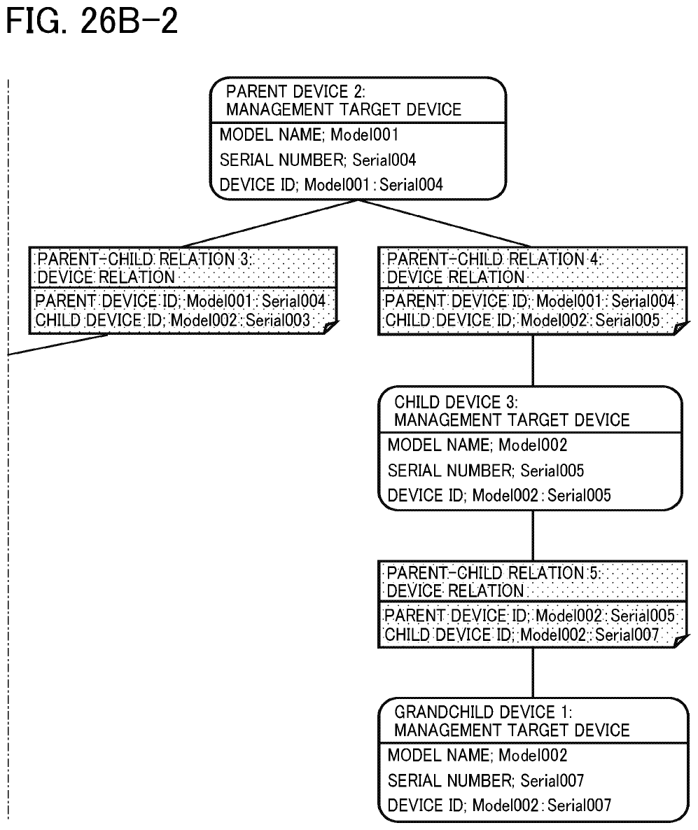

FIG. 26A and FIG. 26B are diagrams illustrating examples of a schematic model of the communication definition of the device according to the third embodiment of the present disclosure. The operation definition and the communication protocol are the same as the communication definition of the first embodiment illustrated in FIG. 7, and the description thereof is omitted. As illustrated in FIG. 26A, in the remote device management system according to the third embodiment, the information transmitted from the device 500 (management target device) which is a monitoring target (management target) of the remote device management apparatus 10 has a concept of device relation. The device relation defines the hierarchical relation of the device 500 by the parent device ID for identifying the parent device of the device 500 and the child device ID for identifying the child device of the device 500. The information on the device relation is stored in a device management table 150c managed by the remote device management apparatus 10 described later. The information transmitted from the device 500 (management target device) is the same as the information illustrated in FIG. 7. Further, FIG. 26B schematically illustrates information transmitted from each device 500 and the content of the device relation based on the hierarchical relation of the devices 500 illustrated in FIG. 25. As illustrated in FIG. 26B, the remote device management system according to the third embodiment can detect the hierarchical relation of the device 500 based on the information transmitted from the device 500 (management target device) and the information on the device relation (parent-child relation).

Device Management Table

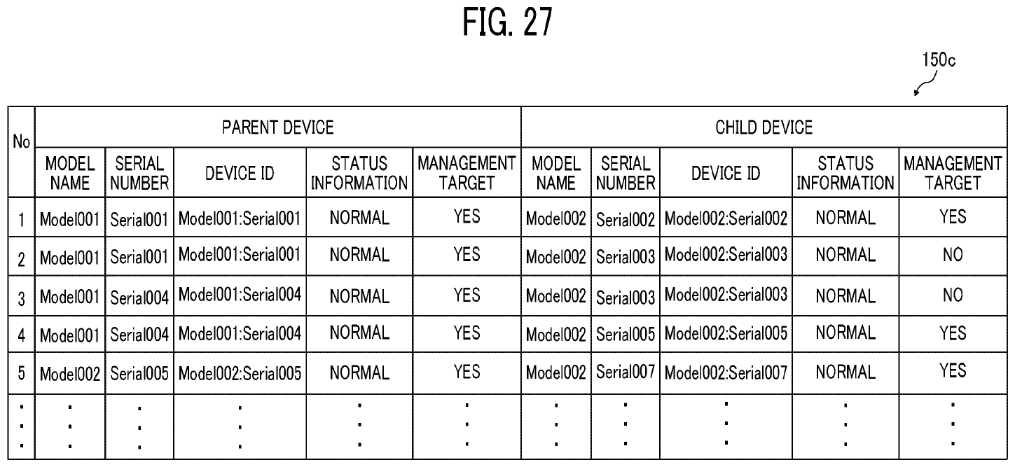

FIG. 27 is a diagram illustrating an example of a device management table according to the third embodiment of the present disclosure. The storage unit 200 of the remote device management apparatus 10 according to the third embodiment stores a device management table 150c instead of the device management table 150a illustrated in FIG. 8. The device management table 150c includes, among the devices 500 to be monitored (managed) by the remote device management apparatus 10, device information related to the device 500 functioning as a parent device and device information related to the device 500 functioning as a child device associated in the hierarchy information. The hierarchy information included in the device management table 150c corresponds to the device relation (parent-child relation) information illustrated in FIG. 26A and FIG. 26B. For example, in the device management table 150c, a child device whose device ID is “Model 002: Serial 003” is associated with a parent device whose device ID is “Model 001: Serial 001” and a parent device “Model 001: Serial 004”. The device management table 150c is an example of device management information. As described above, the remote device management apparatus 10 can detect the hierarchical relation of a plurality of devices 500 included in the local network 7 even when the child device has a relation with a plurality of parent devices by storing the hierarchy information for each device 500 to be monitored (managed).

The parent device management table stored and managed by the mediating apparatus 30 according to the third embodiment may have the same configuration as the parent device management table 350 according to the second embodiment as illustrated in FIG. 22 or the parent device ID may be deleted from the parent device management table 350. The child device management table stored and managed by the device 510 according to the third embodiment may have the same configuration as the child device management table 610b according to the second embodiment as illustrated in FIG. 23 or the parent device ID may be deleted from the child device management table 610b.

### Effect of Third Embodiment

As described above, the remote device management system according to the third embodiment can perform the communication between the remote device management apparatus 10 and the device 550 even when the child device (device 550) is associated with a plurality of parent devices (devices 510), by using the device management table 150c that stores and manages the hierarchical relation (parent-child relation) between the devices 500 that are management targets of the remote device management apparatus 10.

### Other Embodiments

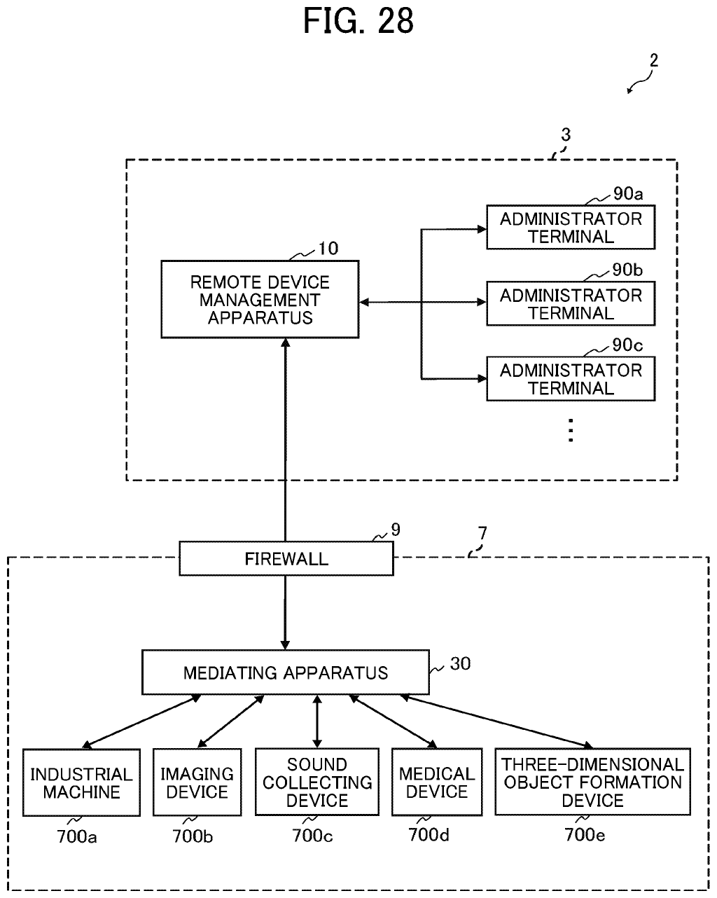

FIG. 28 is a diagram illustrating an example of a system configuration of the remote device management system according to another embodiment of the present disclosure. The difference between the remote device management system 2 illustrated in FIG. 28 and the remote device management system 1 described above is that the types of devices 500 that communicate with the mediating apparatus 30 are different, that is, the usage environment of the device 500 to be managed is different. The device 700 includes an industrial machine 700a, an imaging device 700b, a sound collecting device 700c, a medical device 700d, a three-dimensional object formation device 700e, and the like.

The industrial machine 700a is a processing device, an inspection device, a transport device, a picking device, and the like. The industrial machine 700a transmits device information such as device identification information, operation state, presence/absence of abnormal operation, information on replacement time of consumables, inspection result obtained by the device to the management system 3 (remote device management apparatus 10). The industrial machine 700a transmits device information to the management system 3 (remote device management apparatus 10) using various information transfer formats, such as data or image.

The imaging device 700b and the sound collecting device 700c are devices installed around the industrial machine 700a, for example, to detect the status of the industrial machine 700a. The medical device 700d is a fundus examination apparatus, an X-ray examination apparatus, a sphygmomanometer, a body fat scale, an eye meter, a pacemaker, and the like. The medical device 700d transmits device information such as device identification information, device operation state, presence or absence of abnormal operation, measurement result of the device, etc., to the management system 3 (remote device management apparatus 10). The medical device 700d transmits device information to the management system 3 (remote device management apparatus 10) using various information transfer formats, such as data or image.

The three-dimensional object formation device 700e includes a 3D printer or the like that receives 3D data indicating a shape of a three-dimensional object such as computer aided design (CAD) data and forms a three-dimensional object by depositing a tier of a forming material based on the data. The three-dimensional object formation device 700e uses material extrusion deposition (fused deposition modeling (FDM)), material jetting, binder jetting, powder sinter tiered formation (selective laser sintering (SLS)), stereolithography (SLA) etc., as a formation method. The three-dimensional object formation device 700e transmits the identification information of the device, the operation status of the device, the presence or absence of abnormal operation, the status of the consumables attached to the device, etc., to the management system 3 (remote device management apparatus 10) through the mediating apparatus 30 using various data formats such as numerical data, text data or image data.

In the remote device management system 2 illustrated in FIG. 28, the mediating apparatus 30 is connected to the remote device management apparatus 10 through the firewall 9. The mediating apparatus 30 may have a firmware update function of updating the firmware installed in the device 700 using the internet connection.

In the example illustrated in FIG. 28, the remote device management system 2 illustrates a configuration including a plurality of devices 700 and one mediating apparatus 30, but the remote device management system 2 may further include other devices. For example, when the processing load of one mediating apparatus 30 becomes large, the function for updating the firmware of the device 700 and the function of remote management of the device 700 may be divided and assigned to a plurality of mediating apparatuses.

The device 700 to be managed in the remote device management system 2 is not limited to the example illustrated in FIG. 28. The device 700 may be, for example, a device that has a communication function in a home appliance, a vending machine, a power supply device, an air conditioning system, or a metering system such as gas, water, electricity, and the like.

### Summary of Embodiments

As described above, the remote device management system according to embodiments of the present disclosure includes a plurality of devices 500 connected to the local network 7 and the management system 3 connected to the local network 7 through the firewall 9 and communicating with the mediating apparatus 30 in the local network 7. The plurality of devices 500 are a device 510 (an example of a first device) that communicates with the mediating apparatus, and a device 550 (an example of a second device) that communicates with the device 510 in the local network 7. Further, the device 510 includes a storage unit 600 (an example of a storage unit) that stores device identification information (an example of second device identification information) for identifying the device 550, a mediating apparatus communication unit 511 that receives, from the mediating apparatus 30, a search request for searching the device 500, transmitted from the management system 3 to the mediating apparatus 30, and a mediating apparatus communication unit 511 that transmits to the management system 3, device identification information (one example of first device identification information) for identifying the device 500 and device identification information for identifying the device 550 stored in the storage unit 600 when a search request for device 500 is received. Thus, the remote device management system according to embodiments of the present disclosure can manage the device 550 in the management system 3 even when the device 500 included in the local network 7 has a parent-child relation (for example, the device 510 and the device 550).

Further, in the remote device management system according to embodiments of the present disclosure, the device 510 (an example of the first device) includes a mediating apparatus communication unit 511 that receives a command (an example of request information indicating a predetermined request) for a particular device 550 (an example of a second device) transmitted from the management system 3 to the mediating apparatus 30, and a device communication unit 512 that transmits the received command to the particular device 550 identified by the device identification information (one example of the second device identification information) for identifying the device 550 stored in the storage unit 600. The device 510 further includes a device communication unit 512 that receives a response to a command transmitted from a particular device 550. The mediating apparatus communication unit 511 transmits the received response to the management system 3 by transmitting the response to the mediating apparatus 30. Thus, in the remote device management system according to embodiments of the present disclosure, even when the device 500 included in the local network 7 has a parent-child relation (for example, the device 510 and the device 550), the management system 3 can acquire a response to the command sent from the management system 3 to the device 550.

Furthermore, in the remote device management system according to embodiments of the present disclosure, the management system 3 includes a storage unit 200 that stores a device management table 150a (150b, 150c) (an example of device management information) including device identification information (one example of first device identification information) for identifying the device 510 transmitted from the device 510 (one example of the first device) and device identification information (second example) for identifying the device 550 and a mediating apparatus communication unit 11 that transmits a command (an example of request information indicating a predetermined request) indicating a request for the particular device 550 identified by the device management table 150a (150b, 150c) to the mediating apparatus 30. Thus, in the remote device management system according to embodiments of the present disclosure, device identification information for identifying a device 500 included in the local network 7 can be stored in the management system 3 even when the device 500 included in the local network 7 has a parent-child relation (for example, the device 510 and the device 550).

Further, in the remote device management system according to embodiments of the present disclosure, the device management table 150a (150b, 150c) (an example of the device management information) includes device identification information (an example of first device identification information) for identifying the device 510 (an example of a first device) and device identification information (an example of the second device identification information) for identifying the device 550 (an example of the second device) are stored in association with management target information indicating whether the device 510 and the device 550 are the management targets of the management system 3 and the mediating apparatus communication unit 11 transmits a command (an example of request information indicating a predetermined request) to the particular device 550 identified by the device identification information for identifying the device 550 associated with the management target information indicating that the device is a management target, through the mediating apparatus 30. Thus, the remote device management system according to embodiments of the present disclosure can refrain from managing (monitoring) a device that is not a management target (monitoring target) among the devices 500 identified by the device identification information transmitted from the mediating apparatus 30. For example, when the mediating apparatus 30 and the device 510 are implemented in the same device, the remote device management system can exclude the device 510 from management target.

Furthermore, in the remote device management system according to embodiments of the present disclosure, the management system 3 includes a reception unit 92 that receives a request for a plurality of devices 550 (an example of a second device), and the mediating apparatus communication unit 11 transmits commands (an example of request information indicating a predetermined request) to the plurality of devices 550 for which the request has been received by the reception unit 92 to the mediating apparatus 30. Thus, the remote device management system according to embodiments of the present disclosure can perform communication with the particular device 550 through the mediating apparatus 30 by identifying device identification information for identifying a particular device 550 among the device identification information stored and managed in the device management table 150a. Further, the management system 3 can transmit the commands to the plurality of devices 550 in a batch when necessary. Therefore, the remote device management system can improve the responsiveness of the display screen displayed by the web client 91 of the management system 3 by reducing the number of times of communication, and reduce the time required for communication.

Further, in the remote device management system according to embodiments of the present disclosure, the management system 3 includes a communication unit 11 that receives from the mediating apparatus 30 a response to a command (an example of request information indicating a predetermined request) transmitted from the particular device 550 (an example of the second device) to the mediating apparatus 30 and web client 91 (an example of a display control unit) which causes the display 1006a (an example of a display unit) to display the received response and the device identification information (an example of the second device identification information) for identifying the device 550 in association with each other. Thus, the remote device management system according to embodiments of the present disclosure causes the web client 91 to display the device identification information received by the management system 3 and present the information on the device 500 to be managed to the administrator.

Furthermore, in the remote device management system according to embodiments of the present disclosure, the device management table 150a (150b, 150c) (an example of the device management information) stores device identification information (an example of the second device identification information) for identifying the device 550 (an example of the second device) and device identification information (an example of the first device identification information) for identifying the device 510 (an example of the first device) in association with each other and the command (an example of request information indicating a predetermined request) includes device identification information for identifying the device 510, which is associated with the device identification information for identifying the particular device 550. Then, the mediating apparatus 30 which mediates communication between the management system 3 and the plurality of devices 500 includes a management apparatus communication unit 31 that receives a command to a particular device 550 and a device communication unit 32 that transmits the command to the device 510 identified by the device identification information for identifying the device 510 included in the command. Thus, the remote device management system according to embodiments of the present disclosure manages the device 500 without the limitation of the hierarchy of the device 500 by storing device identification information of a child device (device 550) in association with device identification information (for example, parent device ID) of a parent device (device 510).

Further, in the remote device management system according to embodiments of the present disclosure, the device management table 150a (150b, 150c) (an example of device management information) stores device identification information (an example of second device identification information) for identifying the device 550 (an example of a second device) and a plurality of pieces of device identification information (an example of first device identification information) for identifying a plurality of the devices 510 (an example of the first device) in association with each other and the command (an example of request information indicating a predetermined request) includes a plurality of pieces of device identification information for identifying a plurality of devices 510, which are associated with the device identification information for identifying a particular device 550. Then, the mediating apparatus 30 includes the management apparatus communication unit 31 that receives a command to the particular device 550, and a device communication unit 32 that transmits a command to each of the devices 510 identified by the plurality of pieces of device identification information for identifying the plurality of devices 510 included in the command. Thus, the remote device management system according to an embodiment of the present disclosure can continue to manage the child device even when a parent device is stopped, as a child device (device 550) is associated with a plurality of parent devices (devices 510).

Furthermore, in the remote device management system according to embodiments of the present disclosure, the device communication unit 32 of the mediating apparatus 30 transmits a request from the mediating apparatus 30 for acquiring status information indicating the status of the plurality of devices 550 (an example of a second device) to the device 510 (an example of the first device). In the device 510, the mediating apparatus communication unit 511 receives the acquisition request transmitted from the mediating apparatus 30, the device communication unit 512 transmits the received acquisition request to the plurality of second devices, and the mediating apparatus communication unit 511 collectively transmits to the mediating apparatus 30, a plurality of pieces of status information transmitted from the plurality of devices 550. As a result, the remote device management system according to embodiments of the present disclosure transmits the status information of a plurality of child devices (devices 550) at once from the parent device (device 510) to the mediating apparatus 30, reducing the processing load on the parent device even when the number of child devices increases.

Further, in the remote device management system according to embodiments of the present disclosure the device communication unit 512 of the device 510 (an example of the first device) transmits an acquisition request for the status information indicating the status of the device 550 (an example of the second device) from the device 510 to the device 550. Thus, the remote device management system according to embodiments of the present disclosure can detect a malfunction of the child device in response to an inquiry from the parent device (device 510) even if there is no function to transmit status information to the child device (device 550) spontaneously.

### Supplementary Information on Embodiments

The functions of each embodiment can be implemented by a computer executable program described in a legacy programming language such as assembler, C, C++, C#, Java (registered trademark) or an object oriented programming language, etc. Programs for performing the functions of each embodiment can be distributed through telecommunication lines.

The programs for executing the functions of the embodiments may be stored and distributed on equipment readable recording media such as a ROM, an electrically erasable programmable read-only memory (EEPROM), an erasable programmable read-only memory (EPROM), a flash memory, a flexible disc, a compact disc-read only memory (CD-ROM), a compact disc-rewritable (CD-RW), a digital versatile disc-read only memory (DVD-ROM), a digital versatile disc-random access memory (DVD-RAM), a digital versatile disc-rewritable (DVD-RW), a Blu-ray disc, a Secure Digital (SD) card, a magneto-optical (MO) disc, and the like.

In addition, some or all of the functions of the embodiments may be mounted on a programmable device (PD) such as a field programmable gate array (FPGA) or implemented as an application-specific integrated circuit (ASIC), and distributed by the recording medium as a circuit configuration data (bit stream data) downloaded to the PD in order to implement the functions of the embodiments on the PD, or as data described by Hardware Description Language (HDL), Very High Speed Integrated Circuits Hardware Description Language (VHDL), Verilog-HDL, etc., for generating circuit configuration data.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

What is claimed is:

1. A remote device management system comprising:
a plurality of devices residing on a local network; and
a management apparatus connected to the local network through a firewall and configured to communicate with a mediating apparatus residing on the local network;
the plurality of devices including a first device that communicates with the mediating apparatus and a second device that communicates with the first device in the local network,
the first device comprising circuitry configured to:
store second device identification information for identifying the second device;
receive, from the mediating apparatus, a search request for a device transmitted from the management apparatus to the mediating apparatus; and
transmit first device identification information for identifying the first device and the stored second device identification information to the management apparatus in response to the search request.

2. The remote device management system of claim 1, wherein
the circuitry is further configured to:
receive, from the mediating apparatus, request information indicating a request for a particular second device transmitted from the management apparatus to the mediating apparatus; and
transmit the request information to the particular second device identified by the stored second device identification information.

3. The remote device management system of claim 2, wherein
the circuitry is further configured to:
receive a response to the request information transmitted from the particular second device; and
transmit the response to the management apparatus via the mediating apparatus.

4. The remote device management system of claim 2, wherein
the management apparatus is configured to:
store device management information including the first device identification information and the second device identification information transmitted from the first device; and
transmit the request information indicating a request for the particular second device identified by the device management information to the mediating apparatus.

5. The remote device management system of claim 4, wherein
the device management information further includes management target information indicating whether the first device identified by the first device identification information and the second device identified by the second device identification information are management targets of the management apparatus,
the first device identification information, the second device identification information, and the management target information are associated; and
the management apparatus is further configured to transmit, to the mediating apparatus, the request information for the particular second device identified by the second device identification information associated with the management target information indicating that the second device is to be managed.

6. The remote device management system of claim 4, wherein
the management apparatus is further configured to:
receive a request for the particular second device; and
transmit the request information for the particular second device for which the request has been received to the mediating apparatus.

7. The remote device management system of claim 6, wherein
the management apparatus is further configured to:
receive requests for a plurality of second devices; and
transmit, to the mediating apparatus, the request information to the plurality of second devices for which the request has been received.

8. The remote device management system of claim 2, wherein
the management apparatus is further configured to:
receive, from the mediating apparatus, the response transmitted from the particular second device to the mediating apparatus; and
display the response on a display associating the received response with the second device identification information.

9. The remote device management system of claim 2, wherein
the mediating apparatus is for mediating communication between the management apparatus and the plurality of devices, and is configured to:
receive the request information from the management apparatus; and
transmit the received request information to the first device.

10. The remote device management system of claim 9, wherein
the device management information is stored in association with the second device identification information and the first device identification information; and
the request information includes the first device identification information associated with the second device identification information for identifying the particular second device; and
wherein the mediating apparatus is further configured to, in response to the request information to the particular second device, transmit the request information to the first device identified by the first device identification information included in the request information.

11. The remote device management system of claim 10, wherein
the device management information includes a plurality of pieces of the first device identification information for a plurality of first devices in association with the second device identification information;
the request information includes the plurality of pieces of first device identification information for the plurality of first devices associated with the second device identification information for identifying the particular second device; and
in response to the request information for the particular second device, the mediating apparatus is further configured to transmit the request information to the plurality of first devices identified by the plurality of pieces of first device identification information included in the request information.

12. The remote device management system of claim 9, wherein
the mediating apparatus is further configured to transmit, to the first device, an acquisition request for status information indicating a status of the plurality of the second devices; and
the first device is further configured to:
receive the acquisition request transmitted from the mediating apparatus;
transmit the received acquisition request to the plurality of the second devices, and
collectively transmit a plurality of pieces of the status information transmitted from the plurality of the second devices to the mediating apparatus.

13. The remote device management system of claim 9, wherein
the first device transmits, to the second device, an acquisition request for the status information indicating the status of the second device.

14. The remote device management system of claim 1, wherein
the first device identification information includes a model name and a device identifier of the first device, and the second device identification information includes a model name and a device identifier of the second device.

15. The remote device management system of claim 1, wherein
the first device is further configured to:
store mediating apparatus identification information for identifying the mediating apparatus; and
communicate with the mediating apparatus indicated by the stored mediating apparatus identification information.

16. A first device used in a remote device management system, the remote device management system comprising:
a plurality of devices residing on a local network; and
a management apparatus connected to the local network through a firewall and configured to communicate with a mediating apparatus residing on the local network,
the first device comprising circuitry configured to;
store second device identification information for identifying the second device;
receive, from the mediating apparatus, a search request for the first device or the second device transmitted from the management apparatus to the mediating apparatus; and
in response to the search request, transmit first device identification information for identifying the first device and the stored second device identification information to the management apparatus.

17. The first device of claim 16, wherein the circuitry is further configured to:
receive, from the mediating apparatus, request information indicating a request for a particular second device transmitted from the management apparatus to the mediating apparatus; and
transmit request information to the particular second device identified by the stored second device identification information.

18. A communication method performed by a first device used in a remote device management system, the remote device management system comprising:
a plurality of devices residing on a local network; and
a management apparatus connected to the local network through a firewall and configured to communicate with a mediating apparatus residing on the local network,
the communication method comprising:
storing, in a memory, second device identification information for identifying the second device;
receiving, from the mediating apparatus, a search request for the first device or the second device transmitted from the management apparatus to the mediating apparatus; and
in response to the search request, transmitting first device identification information for identifying the first device and the stored second device identification information to the management apparatus.

19. The communication method of claim 18, further comprising:
receiving, through the mediating apparatus, request information indicating a request for a particular second device transmitted from the management apparatus; and
transmitting the request information to the particular second device identified by the stored second device identification information.
